(19) United States
(12) Patent Application Publication
(10) Pub. No.: US 2010/0191659 A1
(43) Pub. Date: Jul. 29, 2010

(54) SYSTEM, METHOD AND COMPUTER PROGRAM PRODUCT FOR CALCULATING AN APPRAISAL PRICE FOR A HEAVY TRUCK

(76) Inventor: TERRY HEBRON, Flatonia, TX (US)

Correspondence Address: PATTERSON & SHERIDAN, L.L.P., 3040 POST OAK BOULEVARD, SUITE 1500, HOUSTON, TX, 77056, US

(21) Appl. No.: 12/691,059

(22) Filed: Jan. 21, 2010

Related U.S. Application Data
(60) Provisional application No. 61/146,693, filed on Jan. 23, 2009.

(51) Int. Cl. G06Q 50/00; G06K 7/10; G06Q 10/00

(52) U.S. Cl. 705/306; 235/462.01; 235/375

(57) ABSTRACT

A system, method and computer program product for calculating an appraisal price for a heavy truck using a hand-held scanner for scanning a barcode containing data representative of a Vehicle Identification Number (VIN) or other unique alphanumerical identifier for a heavy truck. The scanning of the barcode allows data input and retrieval via a PDA with a database link employing bi-directional data synchronization to maintain updated information. The PDA is linked to a local database that is updated with current wholesale and retail sales data from multiple dealer databases. The updated wholesale and retail sales data is averaged and displayed to the user in response to search criteria entered by the user via the PDA and hand-held scanner, allowing the user to then determine and input an informed retail value for a specific vehicle. The local database is also provided with proprietary reconditioning data for determining and recording reconditioning costs for specific components of a heavy truck. Recondition costs are determined, and recorded for each component when a used component and corresponding used component condition is selected by the user and input via customizable lists and drop-down menus. The individual component recondition costs are then totaled to generate and output a total recondition cost. An appraisal price is calculated when a user inputs a profit margin that is added to the total recondition cost, and then subtracted from the informed retail value to generate an appraisal price indicative of what a user should pay for a specific vehicle, and outputting the appraisal price.

### CROSS-REFERENCE TO RELATED APPLICATIONS

This application claims benefit of U.S. provisional patent application Ser. No. 61/146,693, filed Jan. 23, 2009, which is herein incorporated by reference.

### BACKGROUND OF THE INVENTION

1. Field of the Invention

The present invention relates to the business of computer-implemented vehicle sales and finance, and specifically systems, methods and computer program products for carrying out wholesale vehicle sales.

Since the invention and subsequent evolution of the Internet, electronic data management systems have become a common way to track and manage data for cars and to transmit the data through the network. Systems and methods exist for handling data for new and used cars in order to increase efficiency, eliminate paper files, and lower business transaction times. Furthermore, electronic data can be used to facilitate transactions involving buyers, sellers, wholesalers, and vehicles that are geographically separated from one another. The Internet or World Wide Web often operates on a client/server model wherein a client or user runs a piece of software on a desktop computer, laptop or personal digital assistant (“PDA”) that allows the client or user to use the resources of a host computer or server, such resources including storage, processing and retrieval of data. In such cases, the software operating on the client or user machine is known as a browser, and it contacts the web server to request information from the web server or to provide instructions to the web server. User devices for inputting information to the server or receiving information from the server can include a desktop computer, a laptop computer or a PDA; and associated alphanumeric keypads, touchscreens, and graphical user interfaces (GUI). In effect, users employ the user devices to request host services from the server such as searching, updating, querying and delivering data necessary to conduct business on-line.

### SUMMARY OF THE INVENTION

An embodiment of the invention relates to a system, method and computer program product for calculating an appraisal price for a heavy truck using a hand-held scanner for scanning a barcode containing data representative of a Vehicle identification Number (VIN) or other unique identifier for a heavy truck. The scanning of the barcode allows data input and retrieval via a PDA with a database link employing bi-directional data synchronization to maintain updated information available to the PDA. The PDA is linked to a web server that is updated with current wholesale and retail sales data from multiple dealer databases. The updated wholesale and retail sales data is averaged and displayed to the user in response to search criteria entered by the user via the PDA and hand-held scanner, allowing the user to then determine and input an informed retail value for a specific vehicle.

A web server is also provided with proprietary reconditioning data for determining and recording reconditioning costs for specific components of a heavy truck. Unlike other inventions related to providing appraisal data for cars, the invention allows a user to identify and select specific heavy truck components for a specific heavy truck by make and condition, wherein said heavy truck component selections are available from a highly granulated proprietary database that is routinely upgraded and modified to reflect current available heavy truck components and their respective reconditioning costs. Reconditioning costs are determined and recorded for each component when a used component and corresponding used component condition is selected by the user and input by selecting from customizable lists and drop-down menus. Each component and system of the specific heavy truck can be required to be selected and entered, including all corresponding reconditioning cost sub-selections, before the user is allowed to move along to another component or function of the invention. The individual component recondition costs are then totaled to generate and output a total recondition cost. A user then inputs a profit margin that is automatically added to the total recondition cost. This total is then automatically subtracted from the informed retail value to generate an appraisal price indicative of what a user should pay for a specific vehicle, and outputting the appraisal price to the user.

The described technology in one implementation provides a computer program product for use with a client computer operatively connected to a web server. The web server is updated with wholesale and retail sales data for a heavy truck, manufacturer-specific component and system information, and recondition cost information. The computer program product comprises 131 a computer-readable medium having program code instructions for directing the client computer to: access a web server; synchronize the local memory on the client computer with the web server; receive vehicle listing number input by the user; display selections for wholesale and retail sales data for a heavy truck, manufacturer-specific component and system information, and recondition cost information; receive selections input by the user; determine an appraisal price from selections input by the user; and output the appraisal price to the user and the web server.

Other implementations of the technology provide a method for determining the appraisal price of a heavy truck with a client computer and a web server. The web server is updated with wholesale and retail sales data for a heavy truck, manufacturer-specific component and system information, and recondition cost information. The method of determining the appraisal price comprises the steps of: accessing a web server via the client computer; synchronizing the local memory on the client computer with the web server; receiving vehicle listing number input by the user; displaying selections for wholesale and retail sales data for a heavy truck, manufacturer-specific component and system information, and recondition cost information; receiving selections input by the user; determining an appraisal price from selections input by the user; and outputting the appraisal price to the user and the web server.

Yet other implementations of the technology provide an apparatus for determining the appraisal price of a heavy truck with a client computer and a web server. The web server is updated with wholesale and retail sales data for a heavy truck, manufacturer-specific component and system information, and recondition cost information. The apparatus comprises: a client computer for accessing a web server; synchronization software for synchronizing the local memory on the client computer with the web server; data fields for receiving a vehicle listing number input by the user; a graphical user interface for displaying selections for wholesale and retail sales data for a heavy truck, manufacturer-specific component and system information, and recondition cost information; data fields for receiving selections input by the user; a processor for determining an appraisal price from selections input by the user; a graphical user interface for outputting the appraisal price to the user; and a transmitter for outputting the appraisal price to the web server.

### BRIEF DESCRIPTION OF THE DRAWINGS

FIG. 1 is an Options screen providing selections allowing a user to select their database source.

FIGS. 2 and 3 show an exemplary Login screen and use of a Create Database option to bi-directionally synchronize data on the PDA and the web server.

FIGS. 4 and 5 show an exemplary Login screen providing login functions for hierarchical user data rights.

FIG. 6 shows an exemplary main menu providing hierarchical user functions such as Add A Truck, Scan A Truck, and Truck Appraisal.

FIGS. 7 and 8 show Add Truck functions for a user with administrative rights.

FIGS. 9-18 show various exemplary Edit Truck administrative functions within Scan A Truck that may be employed when the user knows the heavy truck listing number.

FIGS. 19 and 20 show View Truck read-only member functions within Scan A Truck that may be employed when the user knows the heavy truck listing number.

FIGS. 21a and 21b show a screen adapted for scanning or inputting the listing number for truck appraisal functions.

FIG. 22 shows an exemplary central Appraisal Menu providing navigation to all menu options.

FIGS. 23a and 23b show exemplary Tools button selections available from the Appraisal Menu.

FIG. 24 shows Barcode Printing based on a previously entered listing number.

FIGS. 25-28 detail various exemplary button states, sub-menu navigation, and data fields within the Edit Truck screen.

FIGS. 29 and 30 show an exemplary What's The Money screen displaying prices for trucks added and sold within the last 90 days.

FIGS. 31-32 show a detail of the functionality of each exemplary appraisal screen data field type accessed from the Appraisal Menu.

FIGS. 33-35 detail an exemplary General Information option from the Appraisal Menu.

FIGS. 36-51 detail an exemplary Major Components option from the Appraisal Menu.

FIGS. 52-61 detail an exemplary Frame option from the Appraisal Menu.

FIGS. 62-87 detail an exemplary Cab Exterior option from the Appraisal Menu.

FIGS. 88-95 detail an exemplary Cab Interior option from the Appraisal Menu.

FIGS. 96-103 detail an exemplary Engine & Air option on the Appraisal Menu that provides navigation to the Exhaust/Equipment screens.

FIGS. 104-109 detail an exemplary Fuel & Battery option on the Appraisal Menu that provides navigation to the Fuel Tanks/Battery screens.

FIGS. 110-112 detail an exemplary Tires option from the Appraisal Menu.

FIGS. 113-120 detail an exemplary Brakes/Drums option from the Appraisal Menu.

FIGS. 121-122 detail an exemplary Rating option on the Appraisal Menu that provides navigation to the Overall Rating screen.

FIGS. 123-125 detail an exemplary Truck Value option from the Appraisal Menu.

### DETAILED DESCRIPTION OF THE INVENTION

An exemplary computer program, system, and method for practicing the invention is illustrated in the drawings. A “heavy truck,” as described herein is any truck with a gross vehicle weight (GVW) of 19,500 lbs. or more.

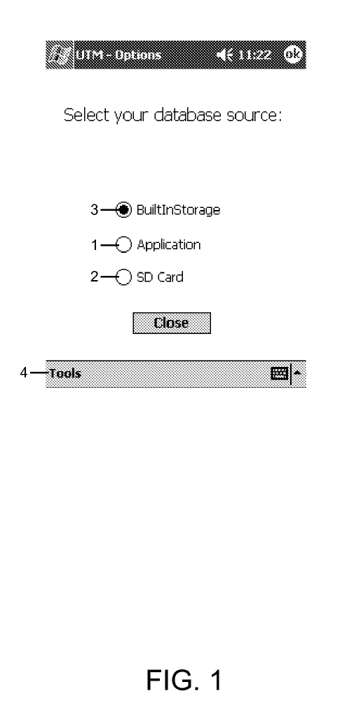

FIG. 1 shows a first Options screen presented via, e.g, a PDA to a user as “Select your database source.” “Select your database source” determines whether the PDA will be operated off-line using only locally stored data, or whether the PDA will be linked and synchronized with a web server by clicking Application 1. By default, the database may be configured so that it will try to use a storage card by clicking SD Card 2. If a storage card is not present, the database may be configured to use main memory by clicking BuiltInStorage 3; however, such defaults are exemplary and other paths are also available. To modify the database path, a user may click on Tools 4 from the login screen, and click Options 644, then select among listed possible choices.

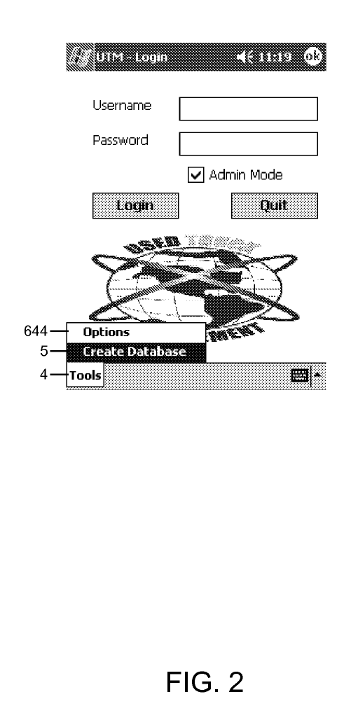

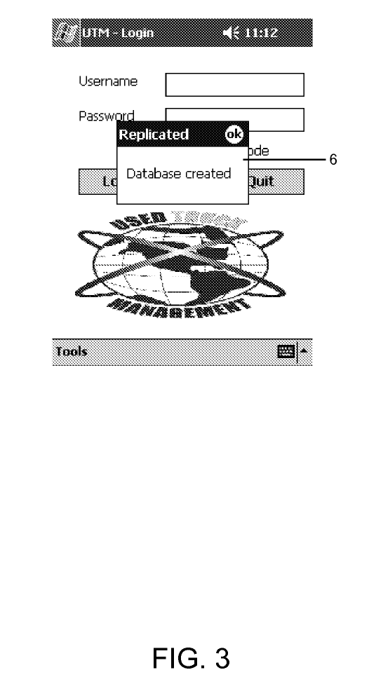

FIGS. 2 and 3 show the Create Database function 5 that allows usage of the application or web server as a database source. Initially, a user's PDA must obtain an updated copy of website database. To do so, first, the user synchronizes the PDA with, e.g., a computer running ActiveSync or other database synchronization software that is connected to the internet. Then, at the login screen the user clicks, e.g., Tools 4 and Create Database 5. Bi-directional synchronization between the web server and the PDA will then start. The process may take several minutes to get completed depending on the speed of the user's internet connection. As shown in FIG. 3, an announcement stating, e.g., “Database created” will appear when bi-directional synchronization has been achieved. The result of the bi-directional synchronization is that the web server is updated with new information entered in the PDA, and the PDA is updated with new information stored on the web server.

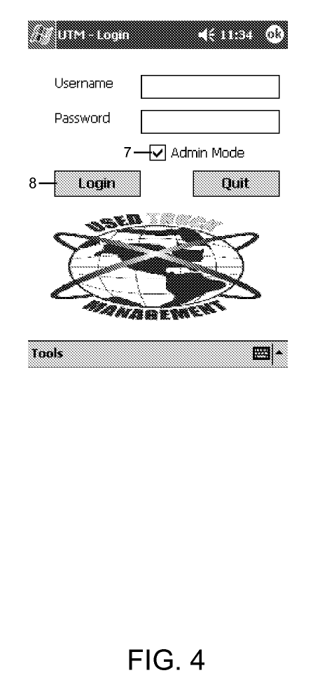

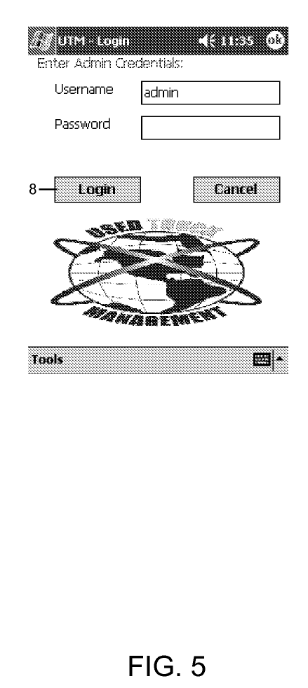

FIGS. 4 and 5 show an exemplary Login screen where a user can login as any website member. Members rights on mobile solutions in many implementations are read-only by design, as opposed to, e.g., members granted administrative rights which are typically unlimited. To gain the write/modify rights associated with administrative rights, the user must update their account with administrative rights. In order to attain administrative rights, an exemplary first step would be to select administrative mode, for example, by checking the Administrative Mode box 7. Then, the user may enter account information or other relevant information, and click Login 8. A new login screen, FIG. 5, will appear asking for, e.g., administrative credentials. Administrative account information may then be entered and Login 8 clicked by the user. The system and application will then identify the user's account and associate it with new truck, added truck and appraisal functions. Once this is accomplished, the user is then brought to, e.g., the application main menu.

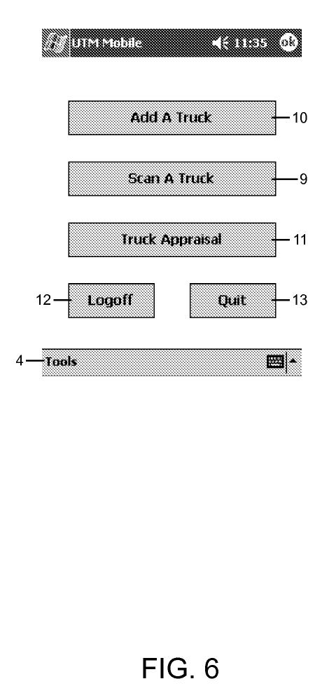

FIG. 6 shows the main menu, which, in some implementations, will only contain a Scan A Truck button 9 if the user is a member user; however, a user with administrative rights may, e.g., add a truck by selecting the Add A Truck button 10, and also access other features such as conducting an appraisal by selecting the Truck Appraisal button 11. Note that there are also two other exemplary buttons; Logoff 12, which brings the user back to the login screen, and Quit 13, which allows one to quit the application.

Bi-directional synchronization may be employed whenever a user wants to upload and/or receive data from the website. Starting at the main menu, once a user's PDA is connected to an internet-enabled computer with, e.g., ActiveSync or other similar database synchronization software, the user can click on Tools 4 on the bottom toolbar and choose Synchronize. In practice, personal or corporate firewalls are known to interpret SQL server mobile synchronization as possible security threats and may block the synchronization function. Synchronization software, in many implementations, must be therefore properly coordinated with security software.

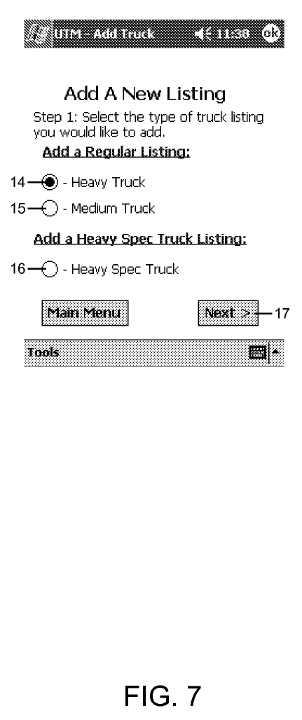

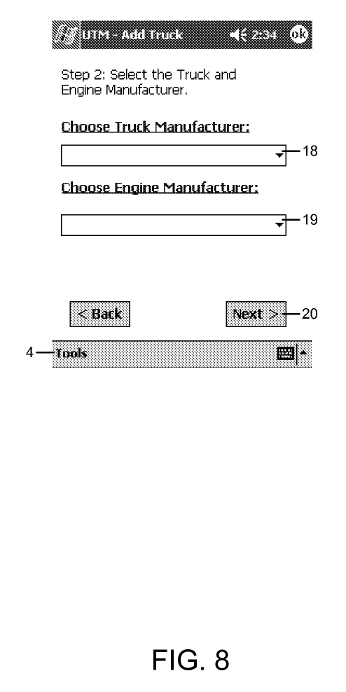

FIGS. 7 and 8 show the Add Truck function. In this example, to add a new truck, a user clicks the Add a Truck button 10 from the main menu, shown in FIG. 6. The user chooses, e.g., the truck type from selections labeled Heavy Truck 14, Medium Truck 15, or Heavy Spec Truck 15; and clicks Next 17. As shown in FIG. 8, the user is then asked to specify truck manufacturer 18 and engine manufacturer 19. After the choices are filled, the user clicks Next 20 and follows instructions under Scan a Truck.

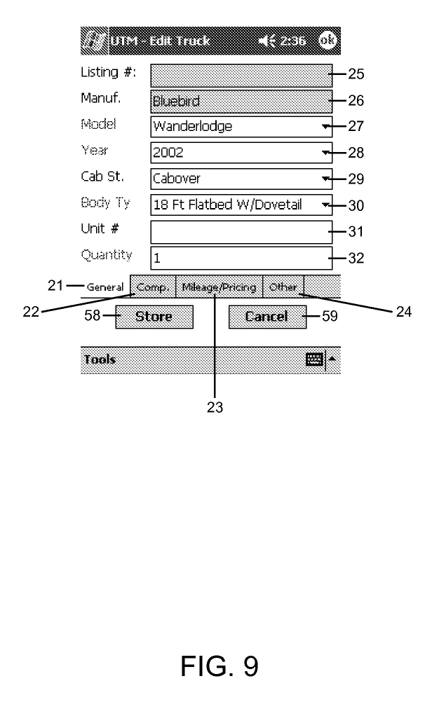

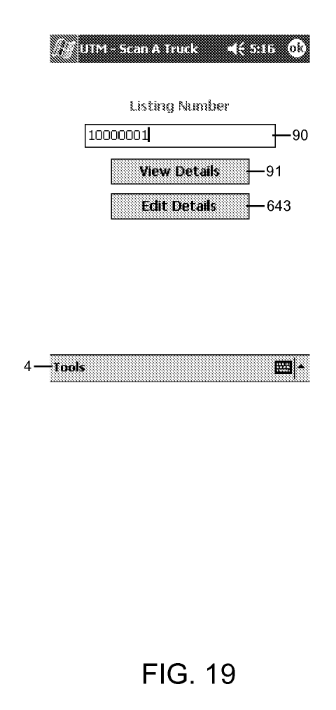

FIG. 9 shows exemplary Edit Truck functions under Scan A Truck as accessed from the General tab 21. Five exemplary tabs are provided, in this instance labeled General 21, Components 22, Mileage/Pricing 23, and Other 24. A form containing, e.g., all possible fields will appear when the General tab is selected, including data fields for Listing Number 25, Manufacturer 26, Model 27, Year 28, Cab Style 29, Body Type 30, Unit Number 31, and Quantity 32. To begin, a user enters the listing number for the heavy truck. Listing numbers in a preferred implementation are unique for a specific vehicle in this system. Listing numbers may be generated by the website. Listing numbers may be programmed and entered in to the system manually using, e.g., an alphanumeric keypad. Alternatively, a barcode representation of the number may be affixed to the vehicle and scanned with a barcode scanner to enter the listing number of the vehicle in to the system. From this point, the workflow from Edit A Truck is the same for either trucks recently added or trucks previously in the system. In order to use Edit Truck when the user knows the listing number, Scan A Truck 9 may be selected from the Main Menu shown in FIG. 6, and, as shown in FIG. 19, the listing number 90 may be entered manually or by scanning the barcode, or a radio frequency identification device (RFID) may be used to detect the listing number for a truck. The user then selects Edit Details 643. Note that certain fields of entry may be mandatory, and are indicated as such by, e.g., appearing red.

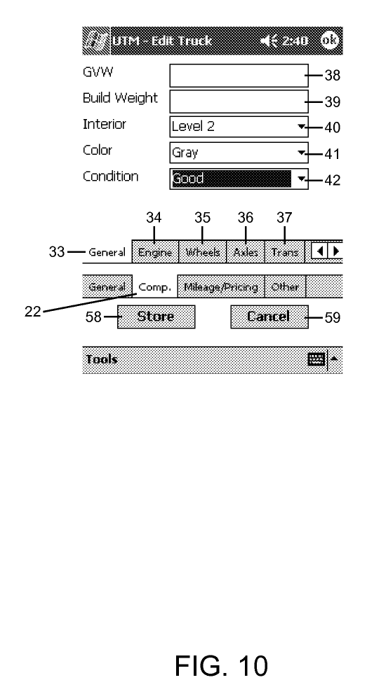

FIGS. 10-15 flow from the Component tab 22 in FIG. 9, and show the screens used to access selections corresponding to General 33, Engine 34, Wheels 35, Axles 36, Transmission 37, and Other 38.

In FIG. 10, the General tab 33 provides exemplary entry screens and drop-down menus to access data fields for Gross Vehicle Weight (GVW) 38, Build Weight 39, Interior 40, Color 41, and Condition 42. The user can then store these selections by electing Store 58 or cancel the selections by selecting Cancel 59, and re-enter new selections.

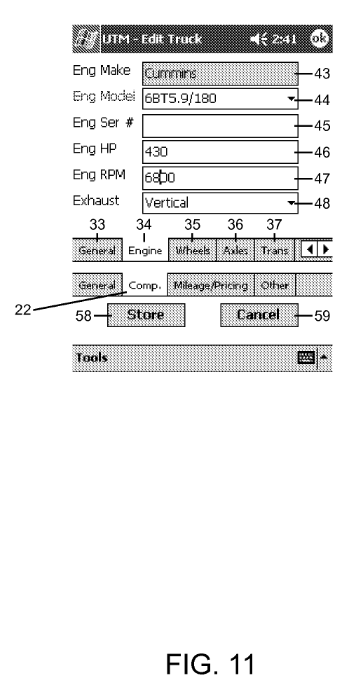

In FIG. 11, the Engine tab 34 provides entry screens and drop-down menus to access data fields for, e.g., Engine Make 43, Engine Model 44, Engine Serial Number 45, Engine Horsepower 46, Engine RPMs 47, Engine Exhaust 48, and the like. The user can then store these selections by electing Store 58 or cancel the selections by selecting Cancel 59, and re-enter new selections.

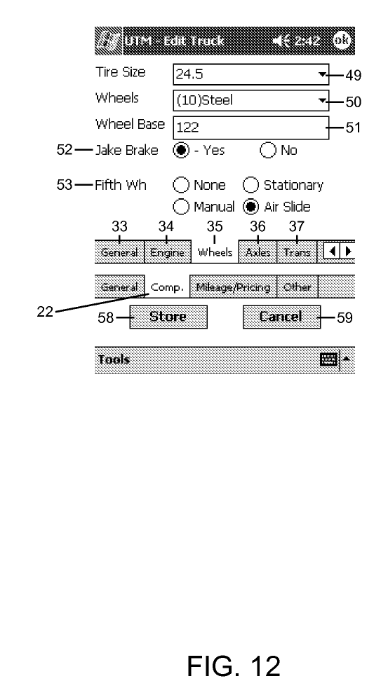

In FIG. 12, the Wheels tab 35 provides entry screens and drop-down menus to access data fields for, e.g., Tire Size 49, Wheels 50, Wheel Base 51, Jake Brake 52, Fifth Wheel 53, and the like. The user can then store these selections by electing Store 58 or cancel the selections by selecting Cancel 59, and re-enter new selections.

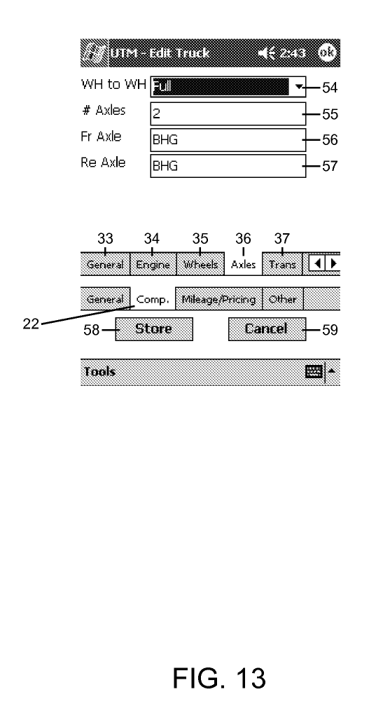

In FIG. 13, the Axles tab 36 provides entry screens and drop-down menus to access data fields for, e.g., Wheel to Wheel Fairing (WH to WH) 54, Number of Axles, Front Axle 56, Rear Axle 57, and the like. The user can then store these selections by electing Store 58 or cancel the selections by selecting Cancel 59, and re-enter new selections.

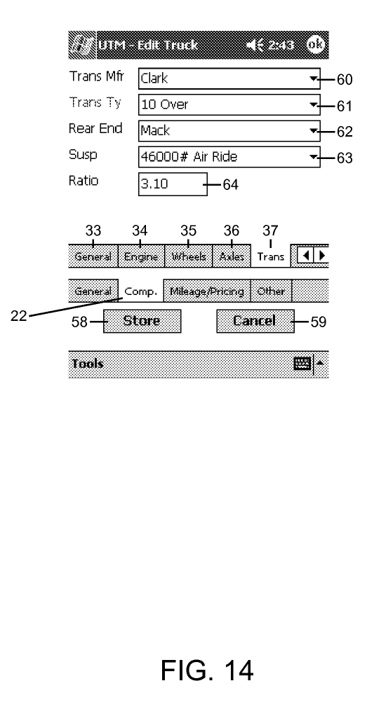

In FIG. 14, the Transmission tab 37 provides entry screens and drop-down menus to access data fields for Transmission Manufacturer 60, Transmission Type 61, Rear End 62, Suspension 63, Ratio 64, and the like. The user can then store these selections by electing Store 58 or cancel the selections by selecting Cancel 59, and re-enter new selections.

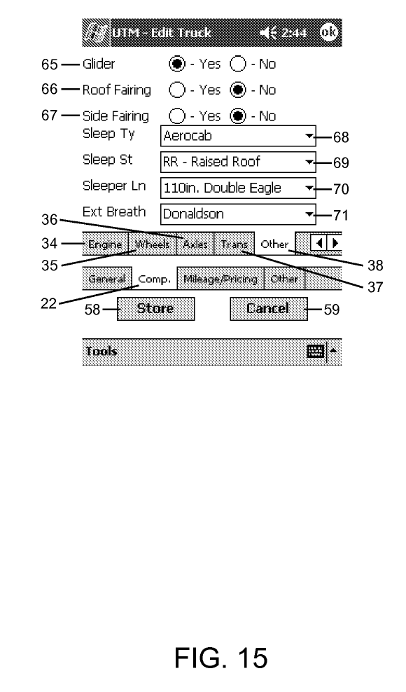

In FIG. 15, the Other tab 38 provides entry screens and drop-down menus to access data fields for, e.g., Glider 65, Roof Fairing 66, Side Fairing 67, Sleeper Type 68, Sleeper Style 69, Sleeper Length 70, Extra Breadth 71, and other such features. The user can then store these selections by electing Store 58 or cancel the selections by selecting Cancel 59, and re-enter new selections.

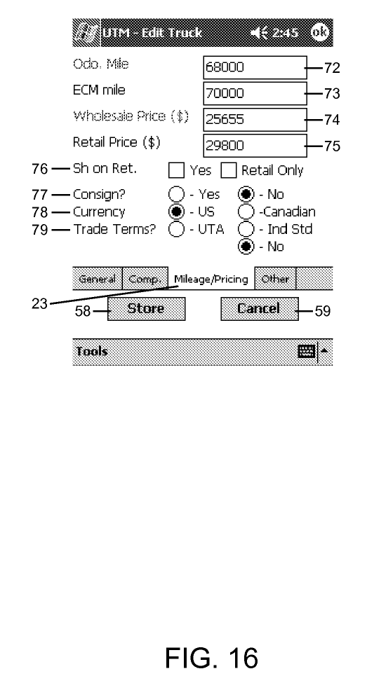

FIG. 16 flows from the Mileage/Pricing tab 23 in FIG. 9, and accesses the data fields for Odometer Mileage 72, Electronic Control Module 73, Wholesale Price 74, Retail Price 75, Show On Retail Site 76, Consignment 77, Currency 78, Trade Terms 79, and other related features that may be provided. The user can then store these selections by electing Store 58 or cancel the selections by selecting Cancel 59, and re-enter new selections.

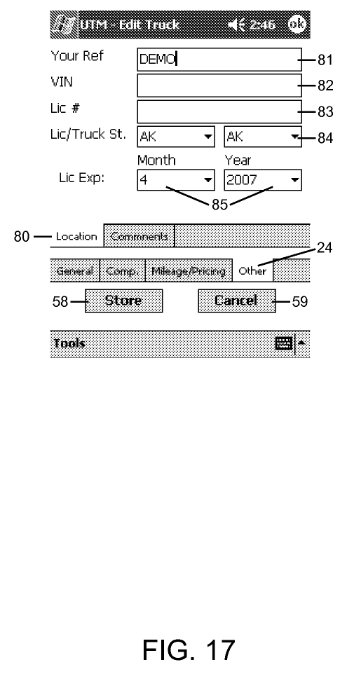

FIG. 17 flows from the Other tab 24 in FIG. 9, and from the Location tab 80, accesses the data fields for Your Reference 81, Vehicle Identification Number (VIN) 82, License Number 83, License/Truck State 84, License Expiration Date 85, and the like. The user can then store these selections by electing Store 58 or cancel the selections by selecting Cancel 59, and re-enter new selections.

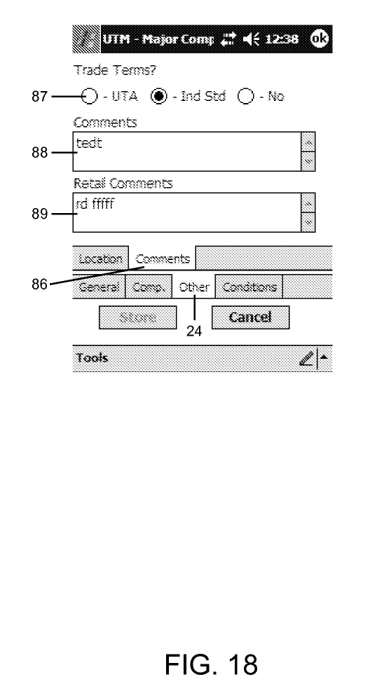

FIG. 18 flows from the Other tab 24 in FIG. 9, and from the Comments tab, allowing a user to access the data fields for Trade Terms 87, Comments 88, Retail Comments 89, etc. The user can then store these selections by electing Store 58 or cancel the selections by selecting Cancel 59, and re-enter new selections.

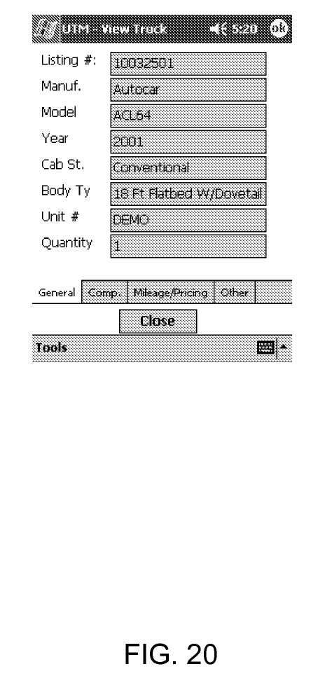

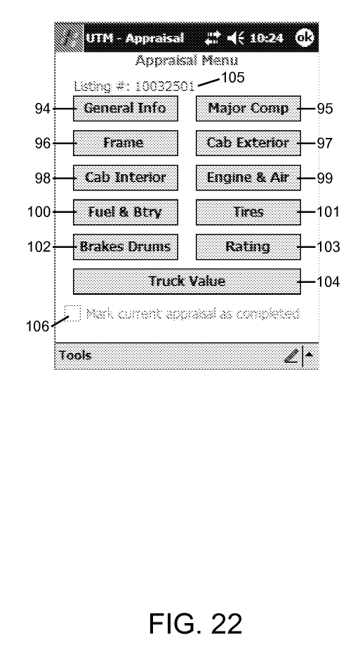

FIGS. 19 and 20 show the View Truck functions available to a user without administrative rights, allowing the user to view truck details shown in FIG. 22 by entering or scanning the Listing Number in data field 90, and clicking View Details 91 as shown in FIG. 19. The form may have a navigation structure similar to the edit mode, but will contain read-only data for a given truck. Alternatively, the read-only version may have a look and feel quite different from the edition mode. The user may also access the Appraisal Menu shown in FIG. 22 or Print options from the Tools menu 4 at the bottom as well.

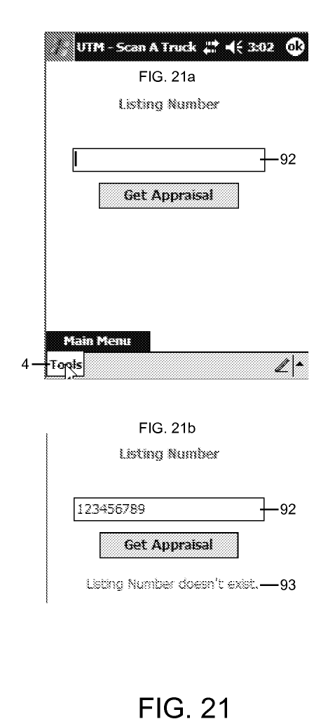

FIG. 21a shows an exemplary screenshot of an optional screen at the start of the truck appraisal process. In this example, a user is prompted to scan or input the Listing Number in data field 92. Although not represented in FIG. 21a, the cursor is located in the textbox, waiting for scan or manual entry. The Scan A Truck option under the main menu shown in FIG. 6, for example, may provide more detail about scanning. Also, the Tools button 4 may allow navigation back to the main menu, which, in this example, is the screen immediately following the login screen.

FIG. 21b shows one implementation wherein if the requested listing number has not previously been stored in the database, an error message 93 is displayed in red. Otherwise, the Appraisal Menu shown in FIG. 22 is displayed.

FIG. 22 displays exemplary options of the Appraisal Menu including General Information 94, Major Components 95, Frame 96, Cab Exterior 97, Cab Interior 98, Engine and Air 99, Fuel & Battery 100, Tires 101, Brakes Drums 102, Rating 103, Truck Value 104, and the like. The previously scanned or input listing number 105 is displayed in red near the top of the screen. Also provided in this example is the “Mark current appraisal as completed” checkbox 106. This checkbox is only available, e.g., to users with administrative rights and will be used to notify that the appraisal has been completed. Editing functions may still be made available to the user after the appraisal has been uploaded for publication on the website.

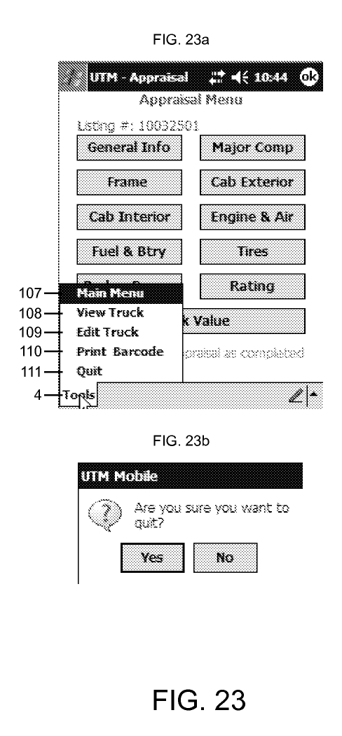

FIG. 23a shows the options Main Menu 107, View Truck 108, Edit Truck 109, Print Barcode 110, and Quit 111; which are available via the Tools button 4 at the bottom of the Appraisal Menu in this example. Main Menu 107 returns the user to the menu displayed immediately following login. Quit 111 completely quits the application and displays, e.g., FIG. 23b, titled UTM Mobile, which queries the user as to whether or not the user wants to quit when Quit 111 is selected. Print Barcode 110 either opens a new screen for selecting the printer to print the barcode or displays an error message stating that there is no connected printer found on this device.

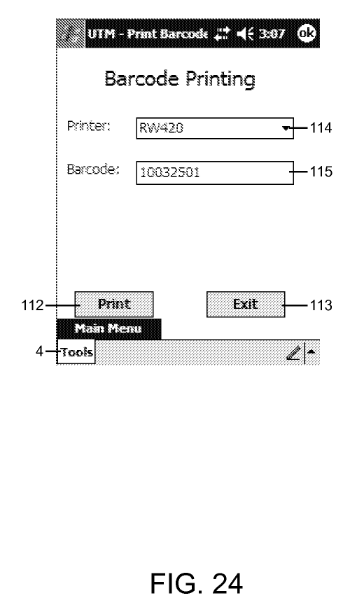

FIG. 24 displays the Print Barcode screen discussed above. When a printer is not found, the Print button 112 is unavailable. Optionally, the system may be configured such that the printer selected 114 for this process is the default value featured in the printer dropdown list. The barcode to be printed 115 corresponds to the listing number entered via a barcode scanner or manually with, e.g., an alphanumeric keypad. The Print button 112 begins the printing process, the Exit button 113 returns to the Appraisal Menu shown in FIG. 23a. Also, the Tools menu 4 optionally allows one to return to the main menu, the screen option shown in FIG. 6 just after the login option.

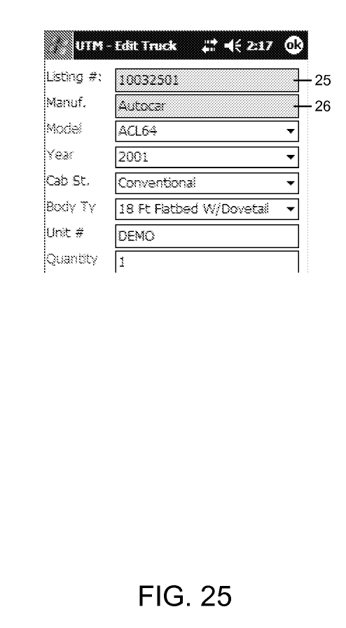

FIGS. 25-27 detail various option states and sub-menu navigation optionally included in preferred aspects of the invention. The View Truck and Edit Truck functions are accessed from the Tools button 4 on the Appraisal Menu shown at FIG. 22. Though these two options are so located in this exemplary embodiment, these options involve truck information functions and not actual appraisal functions, and may be placed elsewhere in alternative embodiments. FIGS. 25-27 detail navigation, and in this exemplary embodiment a user may refer to the Add A Truck function at FIG. 6 for truck additions, and Edit A Truck functions at FIG. 9 for truck edits.

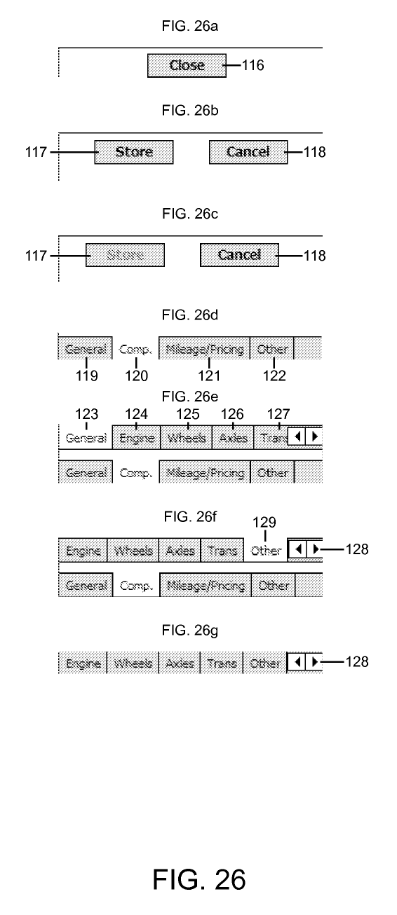

In FIG. 25, Edit Truck has been selected and the top two fields, Listing Number 25 and Manufacturer 26, are highlighted red indicating, e.g., read-only data in those fields. Updateable data in the other fields are not highlighted read-only in this example. Note that the screens for viewing and editing the truck are the same except that when View Truck is selected in this example, all fields are read only and only the Close button 116 is available, as shown in FIG. 26a.

In FIG. 26b, the Edit Truck option has been selected from the screen selections in FIG. 23a. In this exemplary embodiment, a Store button 117 to record changes and a Cancel button 118 are available.

As shown in FIG. 26c, a limited group of individuals, e.g., a user with administrative privileges, has permission to make changes to the specifications of the truck. If a user does not have administrative privileges, e.g. a salesperson, the Store button 117 will be grayed out to indicate that its function is disabled. Also, the Store button 117 function is similarly disabled if the appraisal has been completed.

In the embodiment shown in FIG. 26d, hierarchical navigation through the invention is accomplished by clicking on multiple tabs, including, e.g., General 119, Components 120, Mileage/Pricing 121, or Other 122, to display underlying content.

In the embodiment shown in FIG. 26e, clicking in the Component tab reveals another screen with more tabs indicating selections including General 123, Engine 124, Wheels 125, Axles 126, Transmission 127, and the like.

In FIG. 26f, the number of tabs available exceeds the screen width, so scroll arrows 128 are made available to move other off-screen selections, such as, e.g., Other 129, onto the screen.

In FIG. 26g, an example is provided wherein no highlighted tab is visible. This indicates to the user that the active tab being currently displayed has been scrolled off-screen using the scroll arrows 128.

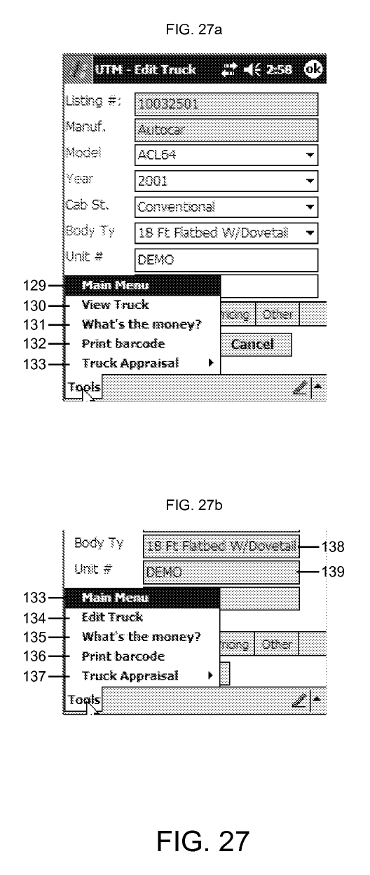

In the embodiment shown in FIG. 27a, the Edit Truck screen Tools options are shown including, e.g., Main Menu 129, View Truck 130, What's the Money 131, Print Barcode 132, and Truck Appraisal 133. Main Menu 129 returns the user to the menu displayed after login shown in FIG. 6. Print Barcode 132 opens the screen shown in FIG. 24 for selecting the printer to print the barcode.

In FIG. 27b, the View Truck screen Tools options are shown including, e.g., Main Menu 133, Edit Truck 134, What's the Money 135, Print Barcode 136, and Truck Appraisal 137. These are the same options available to the user from the Appraisal Menu, Tools option in FIG. 27a. The View Truck read-only mode is indicated in this embodiment by highlighted, locked fields such as Body Type 138 and Unit Number 139.

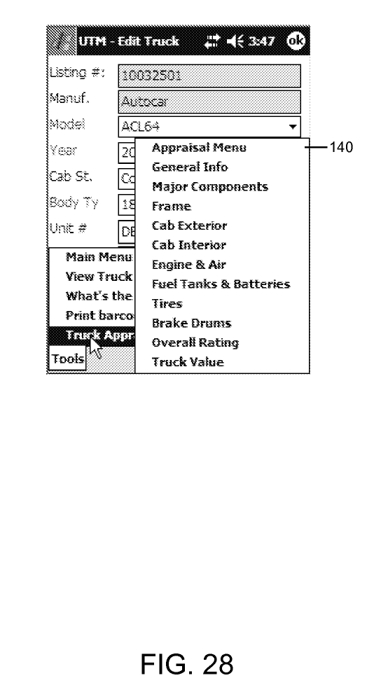

FIG. 28 shows the Truck Appraisal option 133 selected from the Tools button 4, which opens a sub-menu listing all appraisal categories. Each appraisal category corresponds to a button on the Appraisal Menu shown in FIG. 23a except for the Appraisal Menu option 140 that returns to the Appraisal Menu screen shown in FIG. 22.

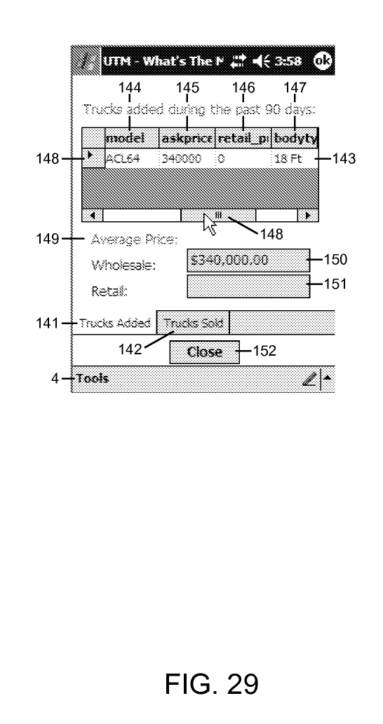

In the embodiment shown in FIG. 29, the What's the Money option selected from the Tools button opens sub-menu listing information tabs titled, e.g, Trucks Added 141 and Trucks Sold 142. These two tabs supply information to the user regarding trucks added to the website database during the past 90 days and trucks sold from participating dealers supplying information to the website database during the past 90 days. The Trucks Added tab in this example displays a grid containing a list of the trucks 143 that have been added to the website database for sale after a complete appraisal. The grid contains fields including, e.g., model 144, asking price 145, retail price 146, body type 147, and the like. All of the grid fields may be viewed by scrolling horizontally on the grid using bar 148. If more than three trucks have been added for the period, vertical scrolling is also provided. Also displayed under Average Price 149 are both Wholesale 150 and Retail 151 prices. The Close button 152 closes this screen and returns to the previous screen, and the Tools menu 4 only offers a Close option that corresponds to the Close button.

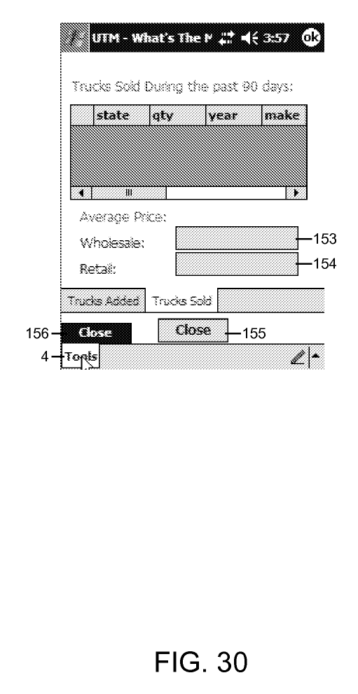

FIG. 30 shows an exemplary Trucks Sold tab, which displays a screen similar to the Trucks Added tab but only shows, e.g., the average wholesale price 153 and retail price 154 of each vehicle, and is limited to the period of time within the last 90 days. The Close button 155 closes this screen and returns to the previous screen, and the Tools menu 4 only offers a Close option 156 that corresponds to the Close button 155.

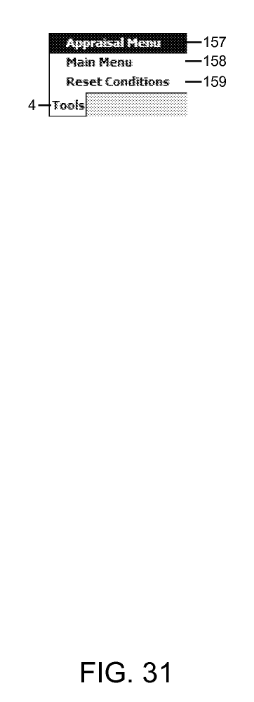

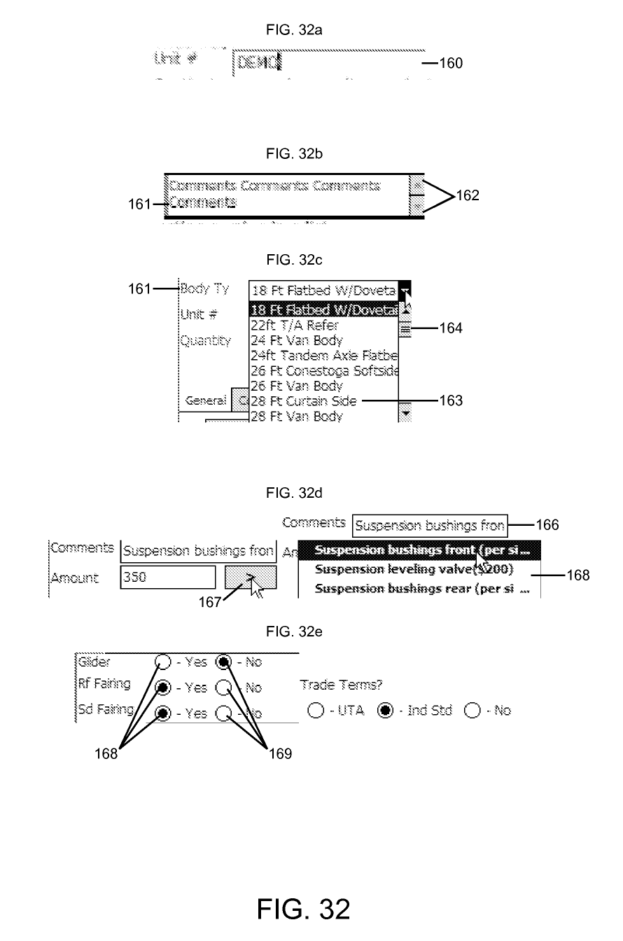

FIGS. 31-32 detail exemplary appraisal options available via the appraisal screens, which are enumerated and categorized together with all relevant information about appraisals. The following figures provide examples of information available, and further summarize available information and indicate where details may be found. Also shown and explained in this example is how a user may navigate between each category of appraisal information. Functions common to all screens shown in this exemplary implementation include a Cancel button allowing a user to return to a previous screen without recording any changes. In addition, Store and Submit buttons allow the user to record changes in the file. Moreover, required fields are flagged with red labels.

In the embodiment shown in FIG. 31, a Tools menu 4 option is shown as the last option in a series displaying selections such as Appraisal Menu 157 for returning to the appraisal menu, Main Menu 150 for returning to the main menu, and Reset Conditions 159, which, e.g., deletes all values in the fields. Note that when using Reset Conditions 159, e.g., values entered prior to the last Store action may be optionally deleted as well.

In the embodiment shown in FIG. 32a, the method of entering text information into the exemplary Unit Number field 160 is shown.

In the embodiment shown in FIG. 32b, an exemplary method of entering more than one line of text information into the exemplary Retail Comments field 161 using scroll arrows 162 is shown.

In the embodiment shown in FIG. 32c, an exemplary method of selecting text information via a drop-down menu 163 and scroll bar 164 from the exemplary Body Type category 165 is shown.

In the embodiment shown in FIG. 32d, an exemplary method of selecting text information 166 by expanding a Comments section via, e.g., a “>” button 167 when the space allowed by the dropdown list 168 is not enough to completely display the list contents is shown.

In the embodiment shown in FIG. 32e, an exemplary method of selecting text information is shown from several options by, e.g, clicking yes 168 or no 169, or by otherwise indicating a multiple choice selection.

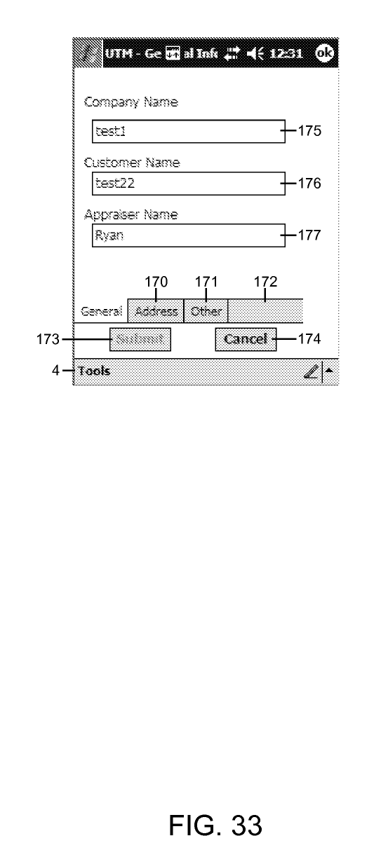

FIGS. 33-35 show the general information screen, depicted, e.g, as accessed from the General Information button 94 on the Appraisal Menu screen shown in FIG. 22. The exemplary screen shows three tabs labeled General 170, Address 171 and Other 172. Also shown are Submit 173, Cancel 174, and a Tools button 4.

In the embodiment shown in FIG. 33, the General tab 170, e.g., accesses data fields for Company Name 175, Customer Name 176, and Appraiser Name 177.

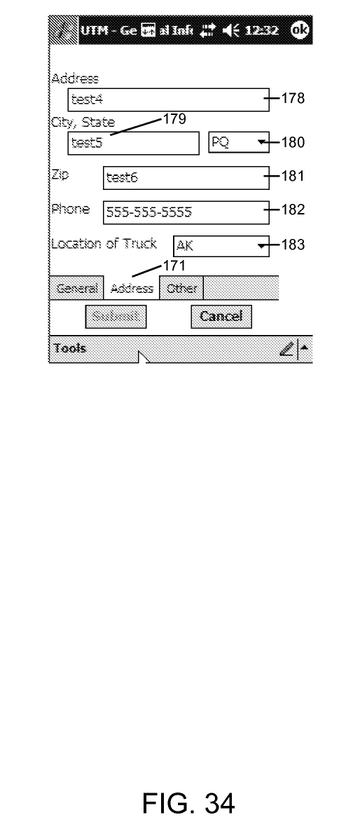

In the embodiment shown in FIG. 34, the Address tab 171, e.g., accesses data fields for Address 178, City 179 and State 180, Zip Code 181, Telephone Number 182, and the Location of the Truck 183.

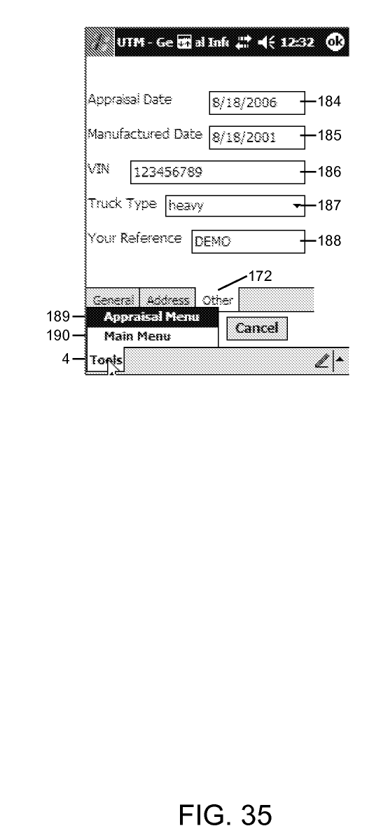

In the embodiment shown in FIG. 35, the Other tab 172 accesses, e.g., data fields for Appraisal Date 184, Manufactured Date 184, VIN 186, Truck Type 187, and Your Reference 188. Also shown are the Appraisal Menu 189 and Main Menu 190 available via, e.g., the Tools 4 button.

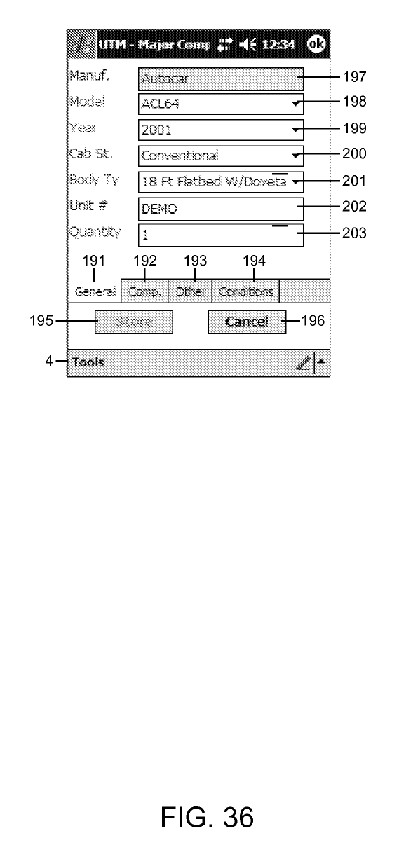

FIGS. 36-51 show the Major Components screen, depicted as accessed from the Major Components button 95 on the Appraisal Menu screen shown in FIG. 22. The screen shows four tabs labeled, e.g., General 191, Components 192, Other 193, and Conditions 194. Also shown are example options including Store 195, Cancel 196, and Tools 4.

In the embodiment shown in FIG. 36, the General tab 191 accesses, e.g., data fields for Manufacturer 197, Model 198, Year 199, Cab Style 200, Body Type 201, Unit Number 202, and Quantity 203.

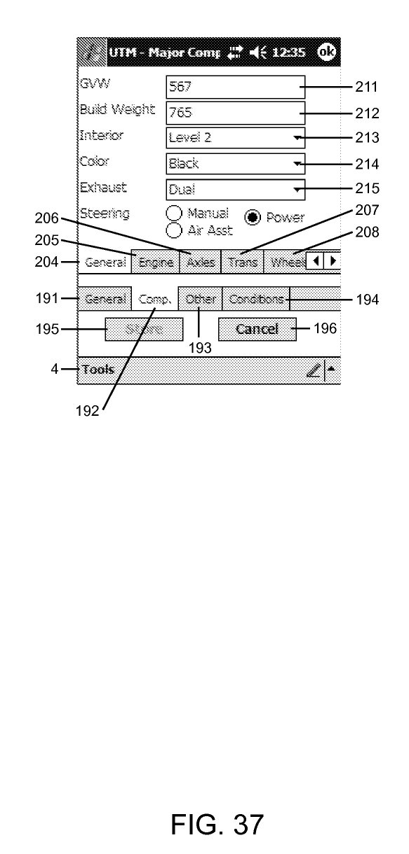

FIGS. 37-43 detail the options available via the Components tab 192, which accesses, e.g., tabs for General 204, Engine 205, Axles 206, Transmission 207, Wheels 208, Mileage 209, and Other 210.

In the embodiment shown in FIG. 37, clicking, e.g., the General tab 204 accesses data fields for Gross Vehicle Weight (GVW) 211, Build Weight 212, Interior 213, Color 214, Exhaust 215, and Steering 216.

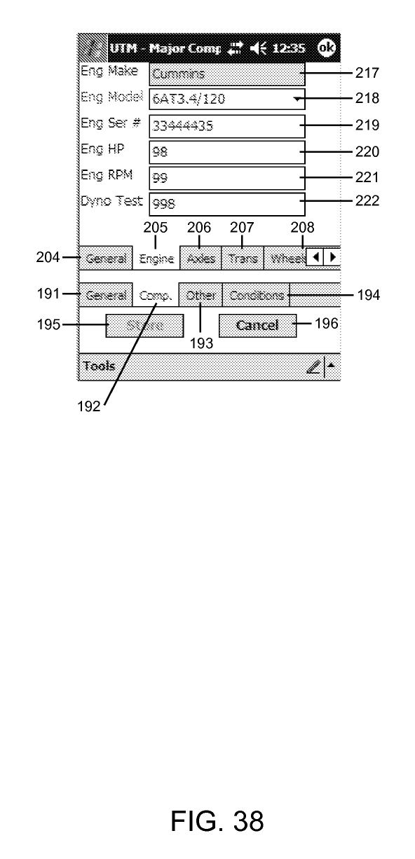

In the embodiment shown in FIG. 38, the Engine tab 205, e.g., accesses data fields for Engine Make 217, Engine Model 218, Engine Serial Number 219, Engine Horsepower 220, Engine Revolutions-Per- Minute 221, and Dyno Test 222.

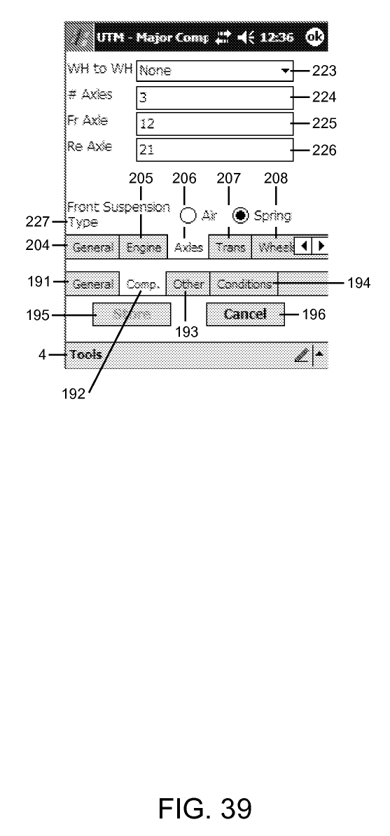

In the embodiment shown in FIG. 39, the Axles tab 206, e.g., accesses data fields for Wheel to Wheel Fairing (WH to WH) 223, Number of Axles 224, Front Axle 225, Rear Axle, and Front Suspension Type 227.

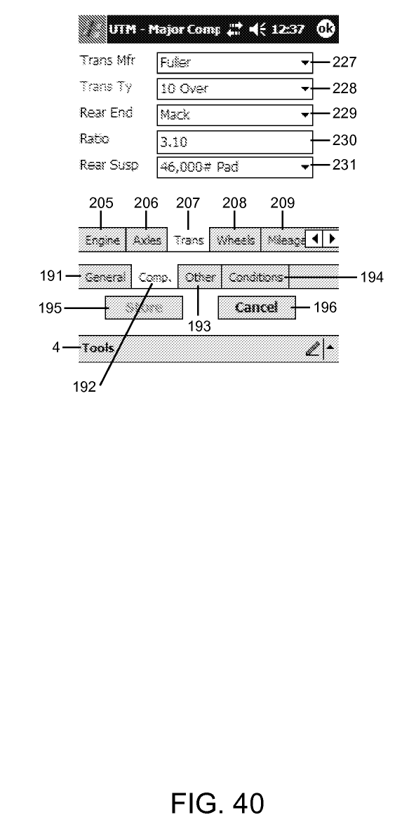

In the embodiment shown in FIG. 40, the Transmission tab 207, e.g., accesses data fields for Transmission Manufacturer 227, Transmission type 228, Rear End 229, Ratio 230, and Rear Suspension 231.

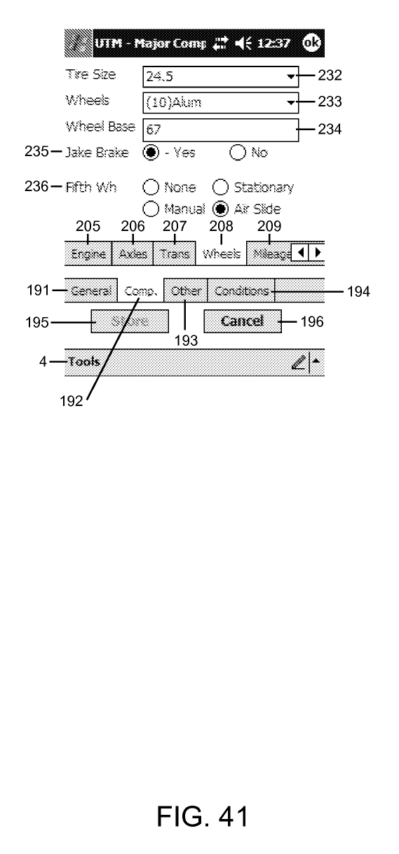

In the embodiment shown in FIG. 41, the Wheels tab 208, e.g., accesses data fields for Tire Size 232, Wheels 233, Wheel Base 234, Jake Brake 235, and Fifth Wheel 236.

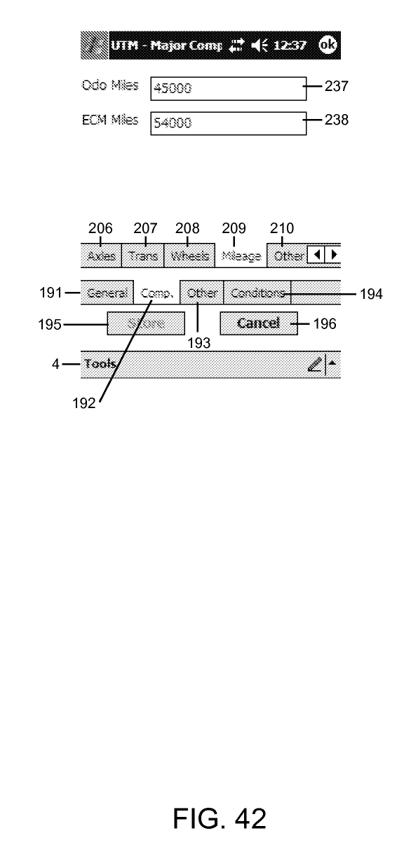

In the embodiment shown in FIG. 42, the Mileage tab 209, e.g., accesses data fields for Odometer Miles 237 and Electronic Control Module Miles 238.

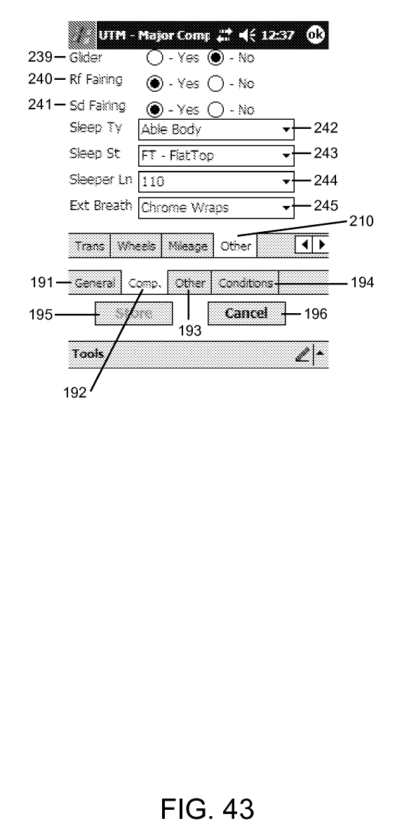

In the embodiment shown in FIG. 43, the Other tab 210, e.g., accesses data fields for Glider 239, Roof Fairing 240, Side Fairing 241, Sleeper Type 242, Sleeper Style 243, Sleeper Length 244, and Exterior Breadth 245.

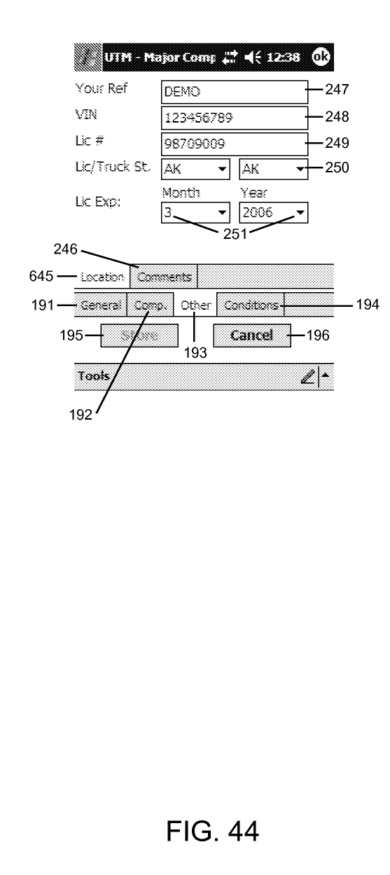

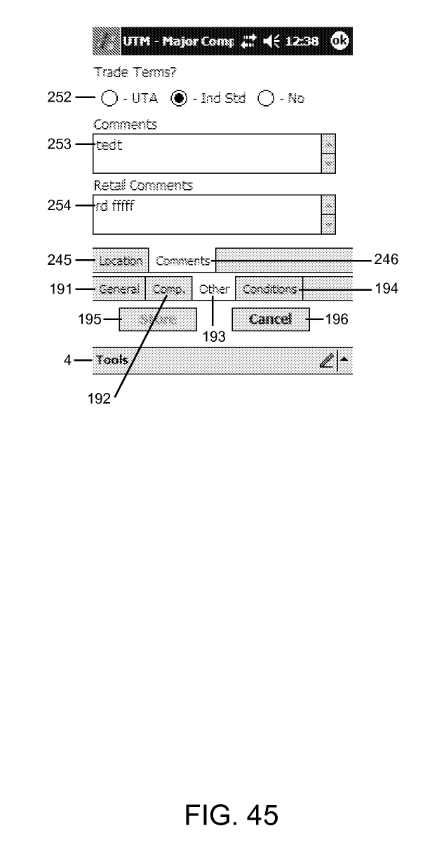

FIGS. 44 and 45 detail the options available via the Other tab 193, which accesses, e.g., tabs for Location and Comments.

In the embodiment shown in FIG. 44, the Location tab 645, e.g., accesses data fields for Your Reference 247, Vehicle Identification Number 248, License Number 249, License and Truck State 250, and 144 License Expiration 251.

In the embodiment shown in FIG. 45, the Comments tab 246, e.g., accesses data fields for Trade Terms 252, Comments 253, and Retail Comments 254.

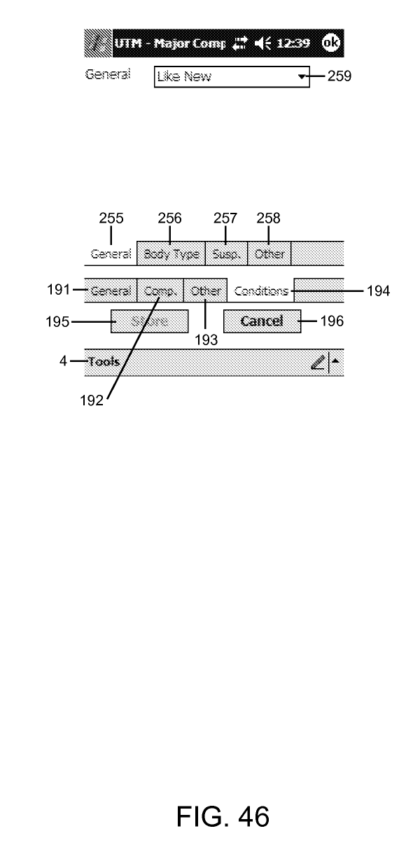

FIGS. 46-51 detail the options available via the Conditions tab 194, which, e.g., accesses tabs for General 255, Body Type 256, Suspension 257, and Other 258.

In the embodiment shown in FIG. 46, the General tab 255, e.g., accesses a General data field 259 for selecting an overall condition.

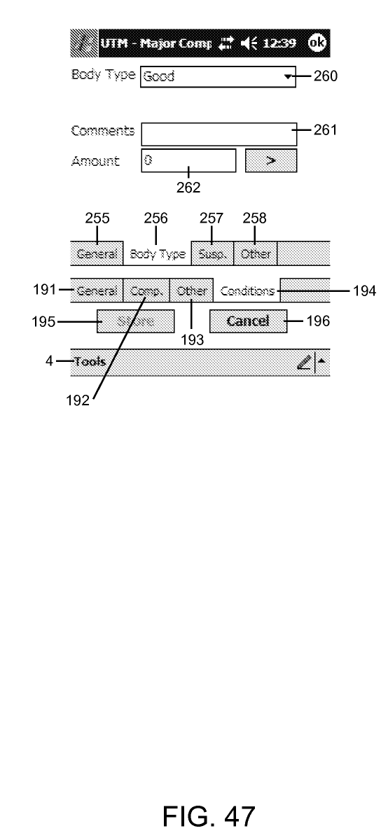

In the embodiment shown in FIG. 47, the Body Type tab 256, e.g., accesses data fields for Body type 260, Comments 261, and Amount 262.

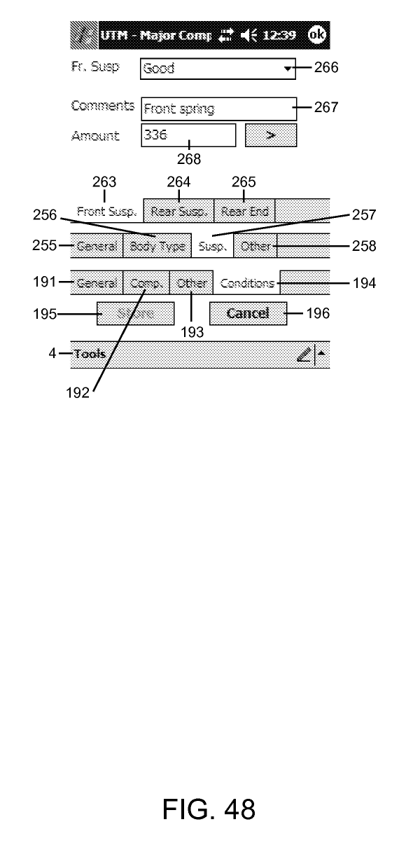

In the embodiment shown in FIGS. 48-50, the Suspension tab 257, e.g., accesses three tabs labeled Front Suspension 263, Rear Suspension 264, and Rear End 265.

In the embodiment shown in FIG. 48, the Front Suspension tab 263, e.g., accesses data fields for Front Suspension 266, Comments 267, and Amount 268.

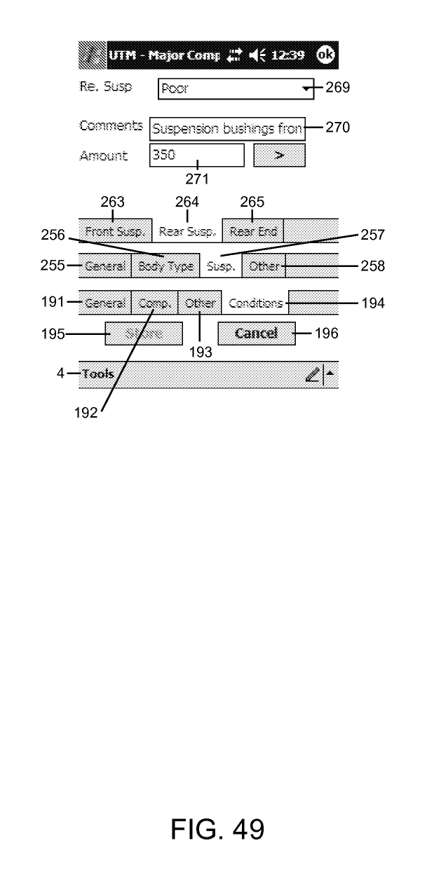

In the embodiment shown in FIG. 49, the Rear Suspension tab 264, e.g., accesses data fields for Rear Suspension 269, Comments 270, and Amount 271.

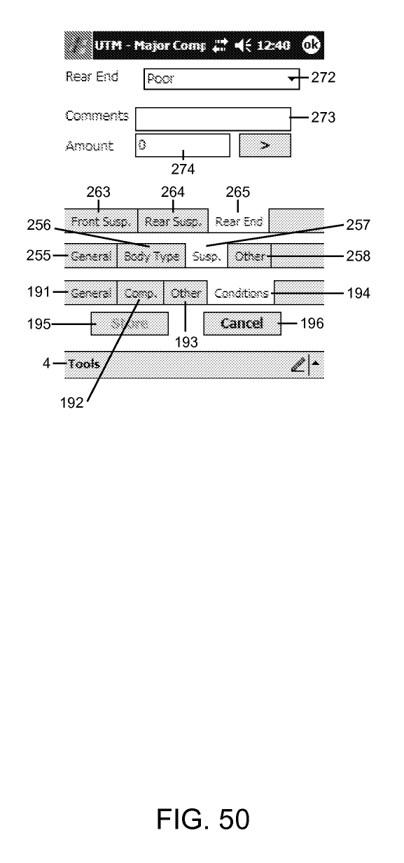

In the embodiment shown in FIG. 50, the Rear End tab 265, e.g., accesses data fields for Rear End 272, Comments 273, and Amount 274.

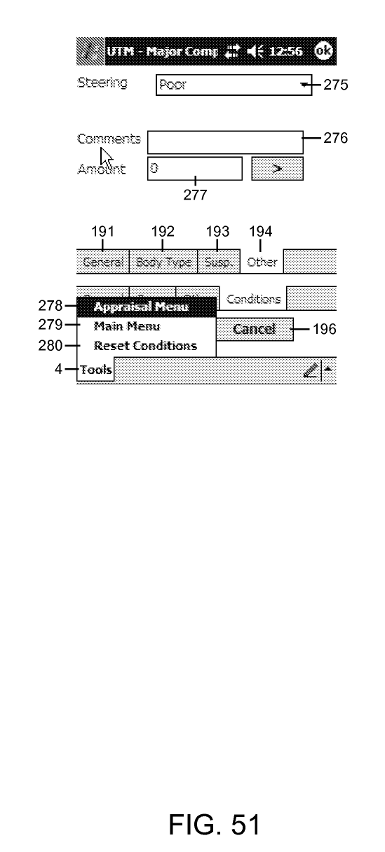

In the embodiment shown in FIG. 51, the Other tab 194, e.g., accesses data fields for Steering 275, Comments 276, and Amount 277. Also shown are the Appraisal Menu 278, Main Menu 279, and Reset Conditions 280 options available, e.g., via the Tools option 4.

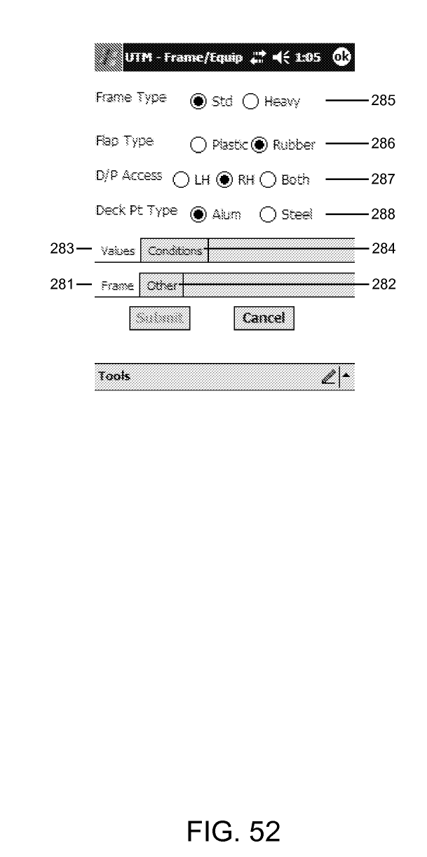

FIGS. 52-61 show the Frame/Equipment screen, depicted, e.g., as accessed from the Major Components button 95 on the Appraisal Menu screen shown in FIG. 22. The screen shows two tabs labeled Frame 281 and Other 282, which then may further access two more tabs labeled Values 283 and Conditions 284.

In the embodiment shown in FIGS. 52-56, the Frame tab 281, e.g., is selected, and not the Other tab 282.

In the embodiment shown in FIG. 52, the Values tab 283, e.g., accesses data fields for Frame Type 285, Flap Type 286, Deckplate (D/P) Access 287, and Deckplate Type 288.

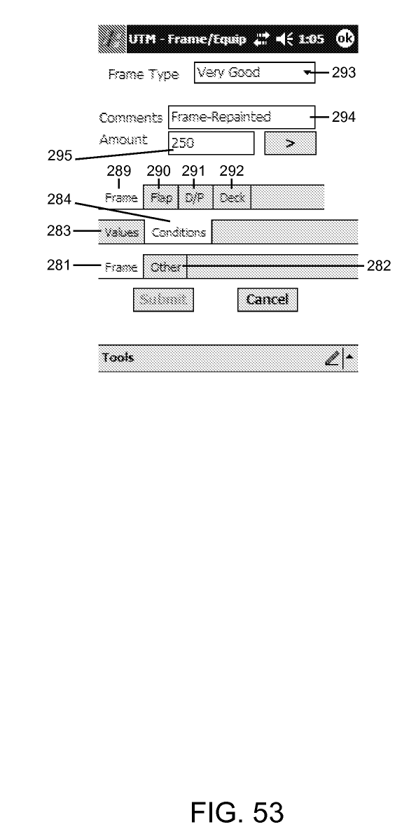

In the embodiment shown in FIGS. 53-56, the Conditions tab 284, e.g., accesses four more tabs labeled Frame 289, Flap 290, Deckplate (D/P) 291, and Deck 292.

In the embodiment shown in FIG. 53, the Frame tab 289, e.g., accesses data fields for Frame Type 293, Comments 294, and Amount 295.

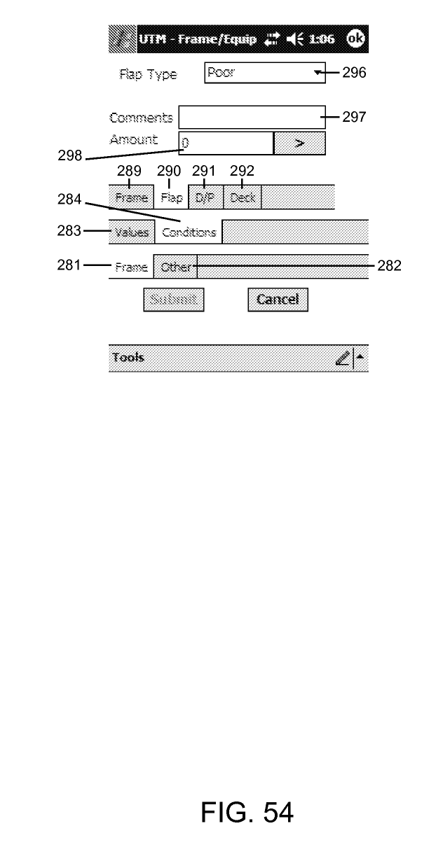

In the embodiment shown in FIG. 54, the Flap tab 290, e.g., accesses data Fields for Flap Type 296, Comments 297, and Amount 298.

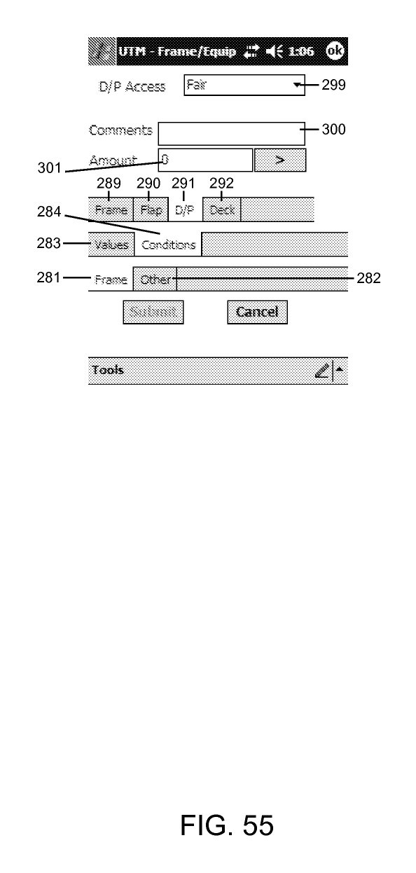

In the embodiment shown in FIG. 55, the Deckplate (D/P) tab 291, e.g., accesses data fields for Deckplate (D/P) Access 299, Comments 300, and Amount 301.

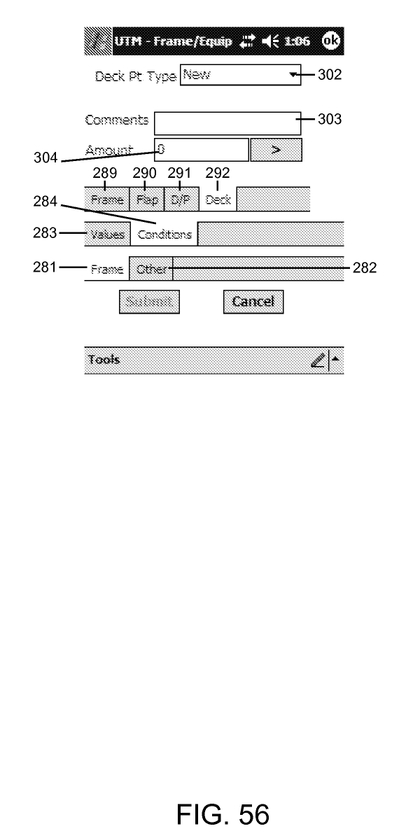

In the embodiment shown in FIG. 56, the Deck tab 292, e.g., accesses data fields for Deckplate Type 302, Comments 303 and Amount 304.

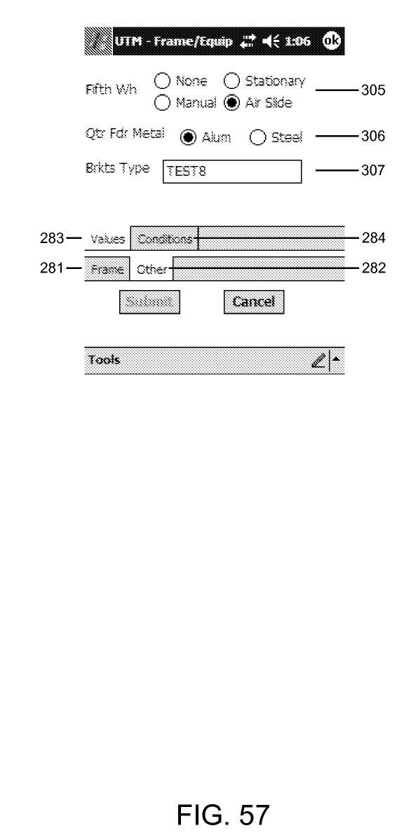

In the embodiment shown in FIGS. 57-61, the Other tab 282, e.g., is selected, and not the Frame tab 281.

In the embodiment shown in FIG. 57, the Values tab 283, e.g., accesses data fields for Fifth Wheel 305, Quarter Fender Metal 306, and Brackets Type 307.

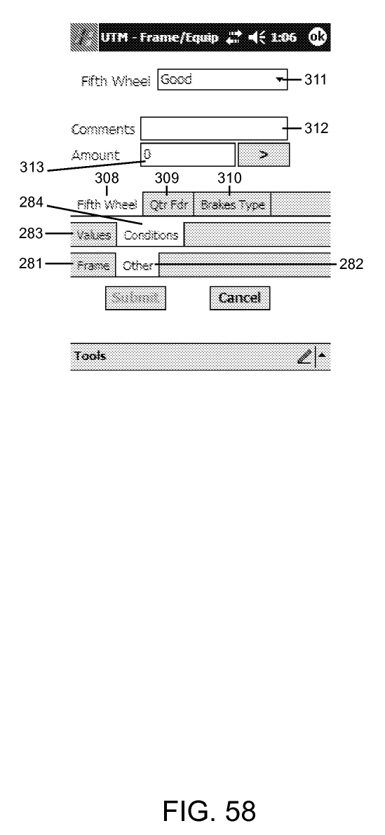

In the embodiments shown in FIGS. 58-61, the Conditions tab 284, e.g., accesses three more tabs labeled Fifth Wheel 308, Quarter Fender 309, and Brakes Type 310.

In the embodiment shown in FIG. 58, the Fifth Wheel tab 308, e.g., accesses data fields for Fifth Wheel 311, Comments 312 and Amount 313.

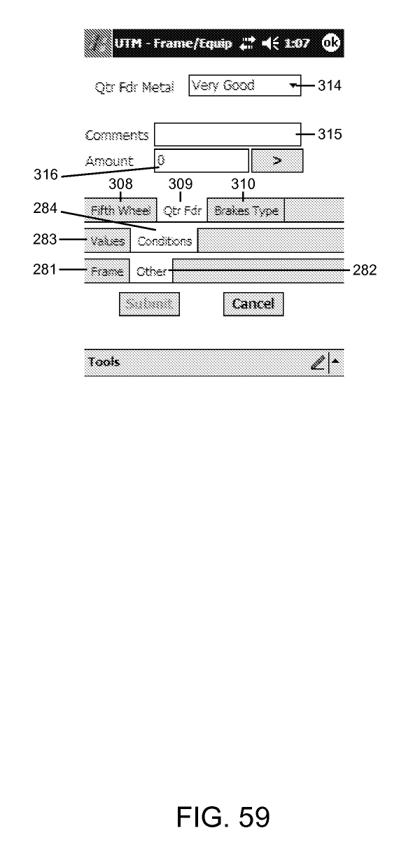

In the embodiment shown in FIG. 59, the Quarter Fender tab 309, e.g., accesses data fields for Quarter Fender Metal 314, Comments 315, and Amount 316.

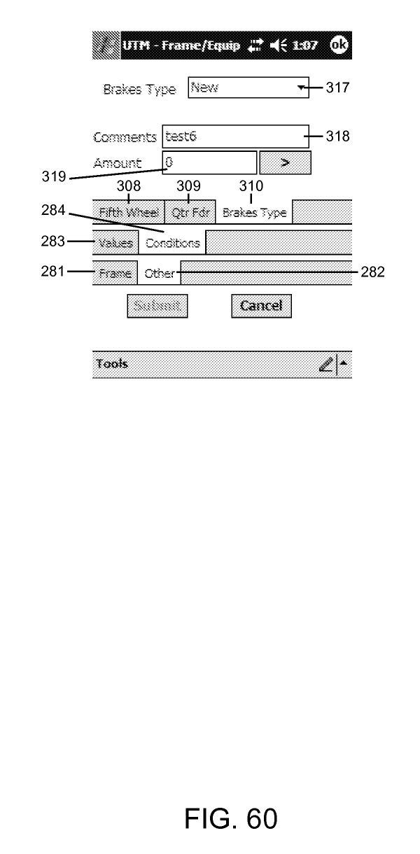

In the embodiment shown in FIG. 60, the Brakes Type tab 310, e.g., accesses data fields for Brakes Type 317, Comments 318, and Amount 319.

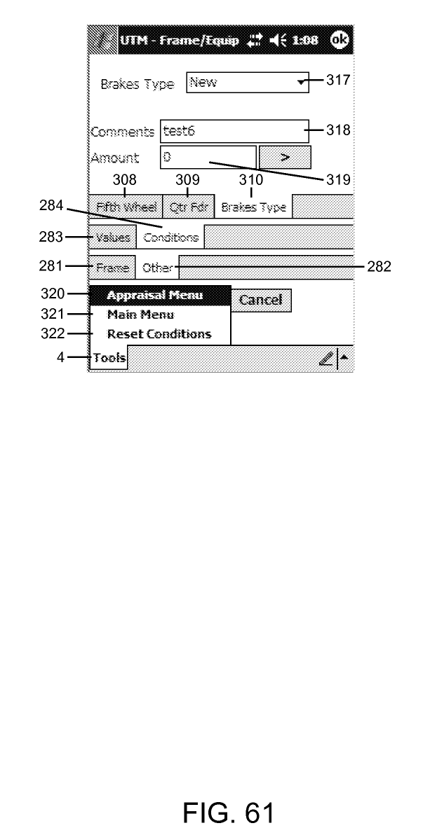

In the embodiment shown in FIG. 61, shown are the Appraisal Menu 320, Main Menu 321, and Reset Conditions 322 options available via the Tools 4 button.

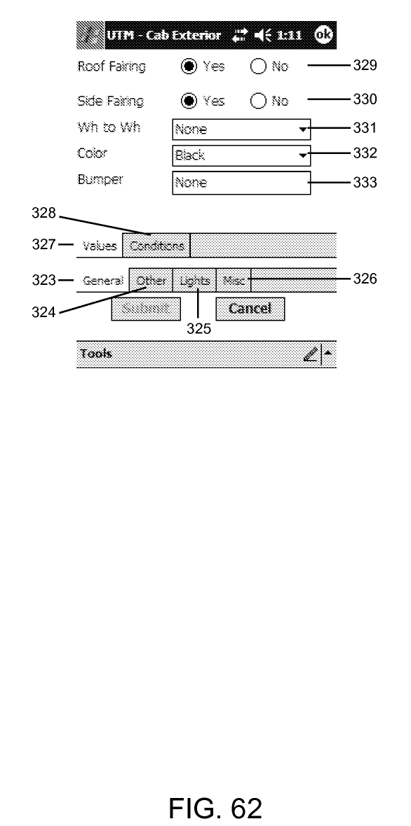

FIGS. 62-87 show the Cab Exterior screen, depicted, e.g., as accessed from the Major Components option 95 on the Appraisal Menu screen shown in FIG. 22. The screen shows four tabs labeled, e.g., General 323, Other 324, Lights 325, and Miscellaneous 326; which then each further access two more tabs labeled Values 327 and Conditions 328.

In the embodiment shown in FIG. 62, the General tab 323, e.g., accesses the Value tab 327, which may then access data fields for Roof Fairing 329, Side Fairing 330, Wheel to Wheel 331, Color 332, and Bumper 333.

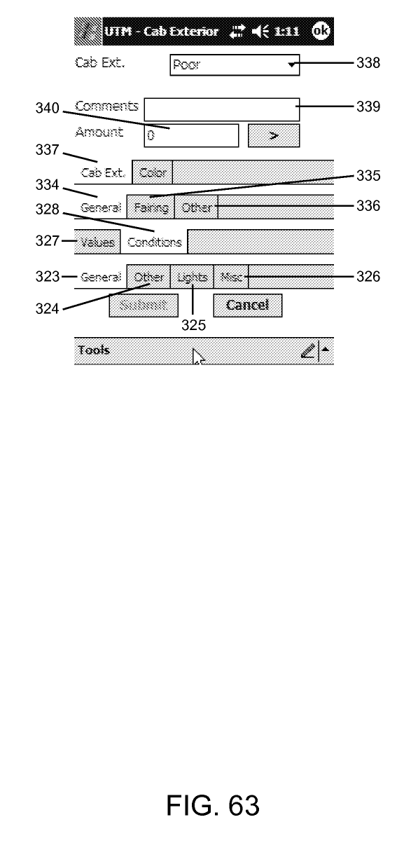

In the embodiment shown in FIGS. 63-68, the General tab 323, e.g., accesses the Conditions tab 328, which may then access three tabs labeled General 334, Fairing 335, and Other 336.

In the embodiment shown in FIG. 63, the second General tab 334, e.g., accesses a Cab Exterior tab 337, which may access data fields for Cab Exterior 338, Comments 339 and Amount 340.

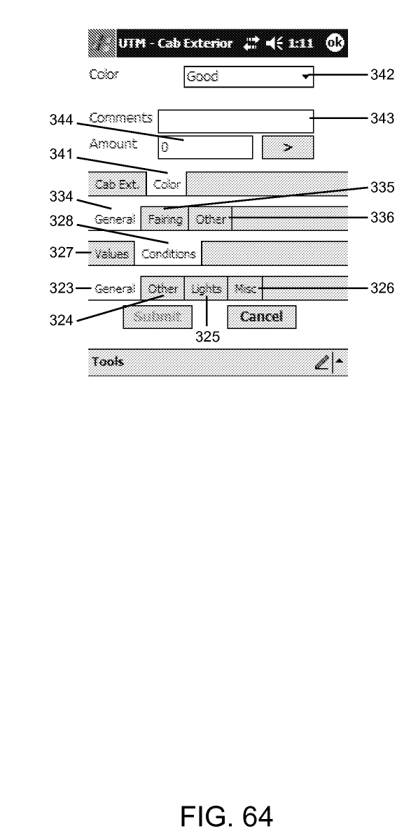

In the embodiment shown in FIG. 64, the second General tab 334, e.g., accesses a Color tab 341 which may access data fields for Color 342, Comments 343 and Amount 344.

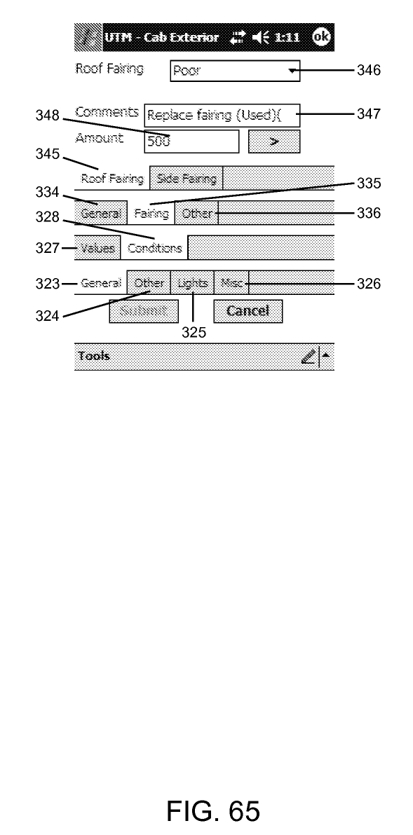

In the embodiment shown in FIG. 65, the Fairing tab 335, e.g., accesses a Roof Fairing tab 345, which may access data fields for Roof Fairing 346, Comments 347 and Amount 348.

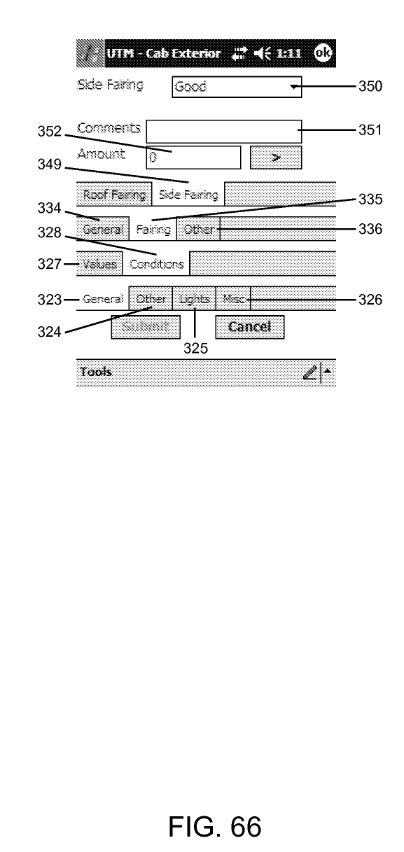

In the embodiment shown in FIG. 66, the Fairing tab 335, e.g., accesses a Side Fairing tab 349, which may access data fields for Side Fairing 350, Comments 351 and Amount 352.

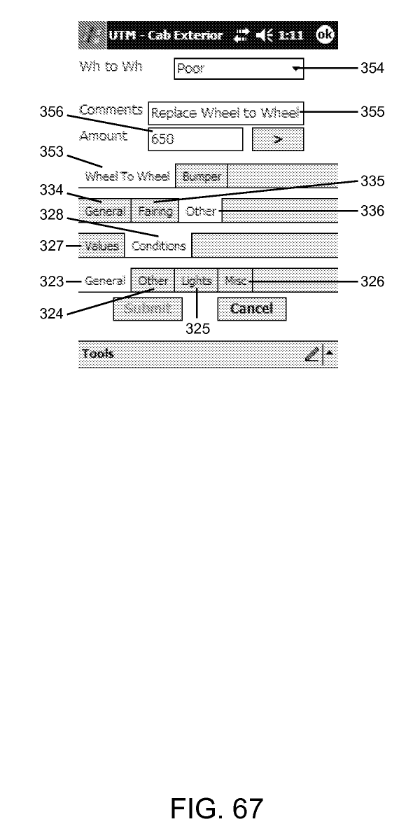

In the embodiment shown in FIG. 67, the Other tab 336, e.g., accesses a Wheel to Wheel tab 353, which may access data fields for Wheel to Wheel 354, Comments 355 and Amount 356.

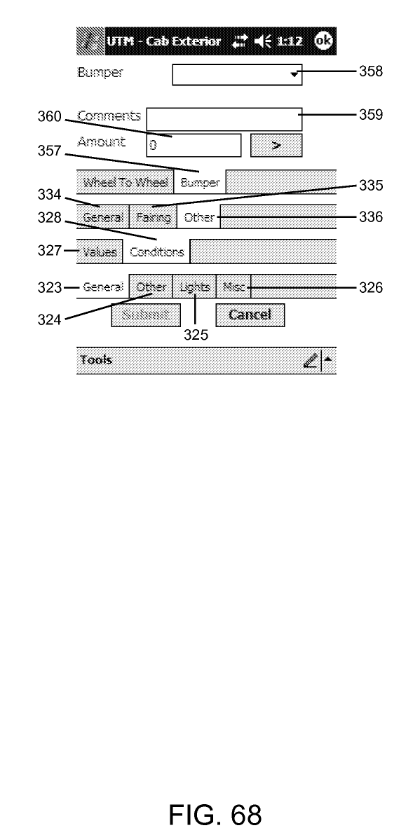

In the embodiment shown in FIG. 68, the Other tab 336, e.g., accesses a Bumper tab 357, which may access data fields for Bumper 358, Comments 359 and Amount 360.

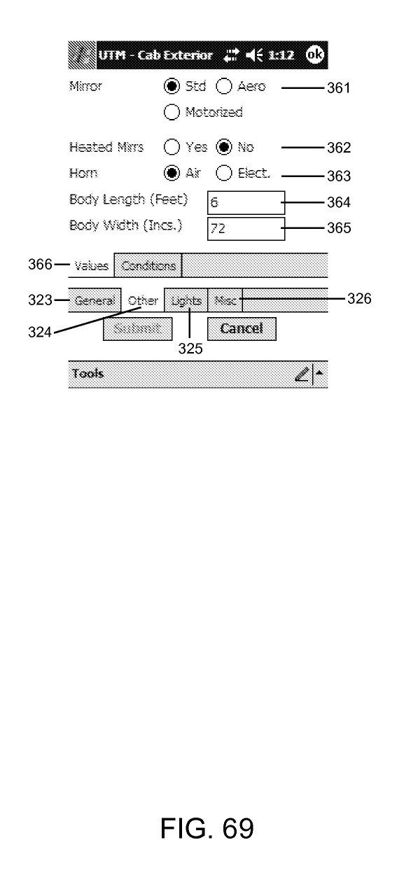

In the embodiment shown in FIG. 69, the Other tab 324, e.g., accesses the Values tab 366, which may then access data fields for Mirror 361, Heated Mirrors 362, Horn 363, Body Length in Feet 364, and Body Width in Inches 365.

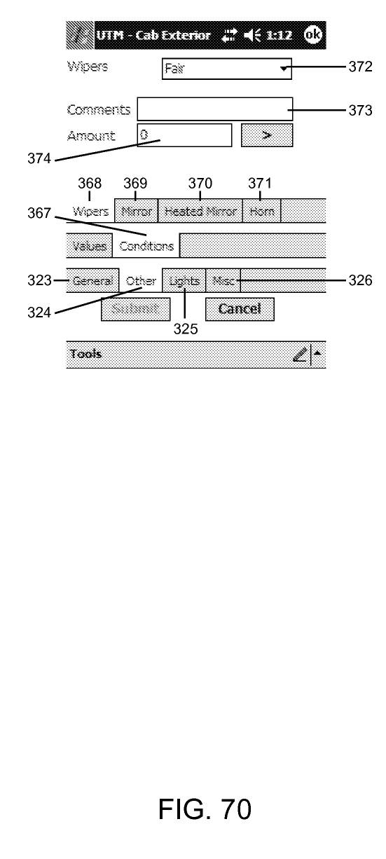

In the embodiments shown in FIGS. 70-73, the Other tab 324, e.g., accesses the Conditions tab 367, which may then access tabs labeled Wipers 368, Mirror 369, Heated Mirror 370, and Horn 371.

In the embodiment shown in FIG. 70, the Wipers tab 368, e.g., accesses data fields for Wipers 372, Comments 373 and Amount 374.

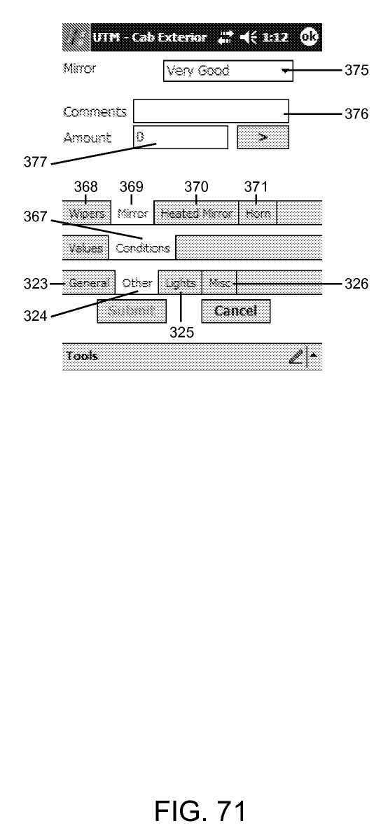

In the embodiment shown in FIG. 71, the Mirror tab 369, e.g., accesses data fields for Mirror 375, Comments 376 and Amount 377.

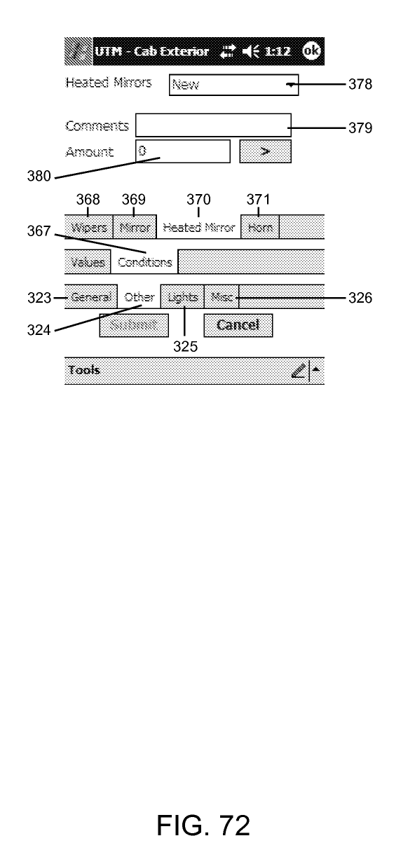

In the embodiment shown in FIG. 72, the Heated Mirror tab 370, e.g., accesses data fields for Heated Mirrors 378, Comments 379 and Amount 380.

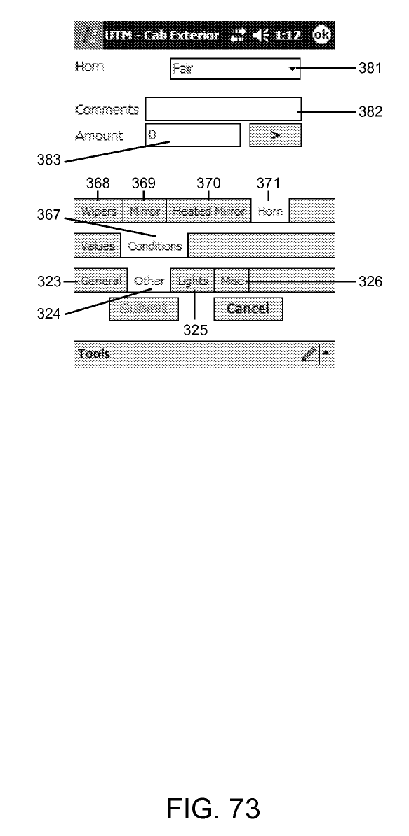

In the embodiment shown in FIG. 73, the Horn tab 371, e.g., accesses data fields for Horn 381, Comments 382 and Amount 383.

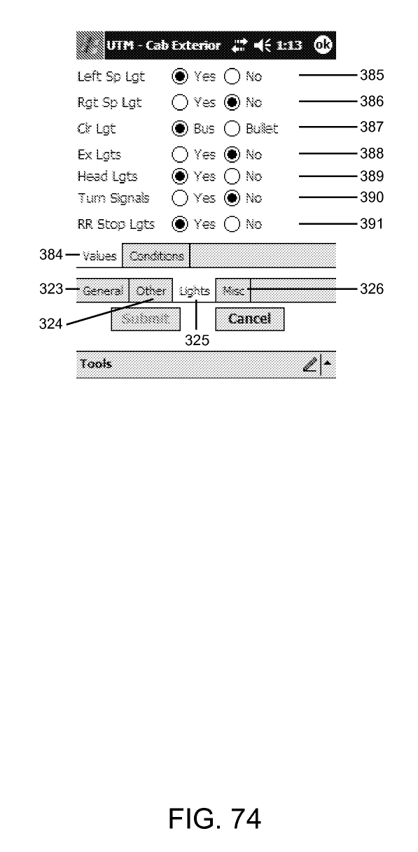

In the embodiment shown in FIG. 74, the Lights tab 325, e.g., accesses the Values tab 384, which may access data fields for Left Spot Light 385, Right Spot Light 386, Clearance Light 387, Exterior Lights 388, Head Lights 389, Turn Signals 390, and Right Rear Stop Lights 391.

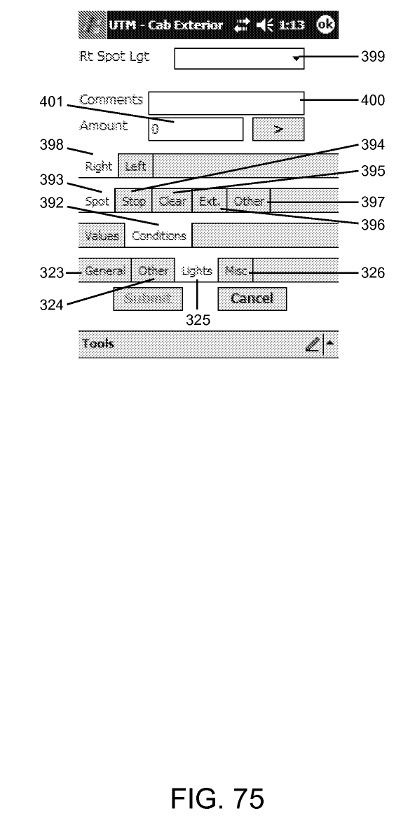

In the embodiments shown in FIGS. 75-81, the Lights tab 325, e.g., accesses the Conditions tab 392, which may then access tabs labeled Spot 393, Stop 394, Clear 395, Extra 396, and Other 397.

In the embodiment shown in FIG. 75, the Spot tab 393, e.g., accesses a Right tab 398, which may then access data fields for Right Spot Light 399, Comments 400 and Amount 401.

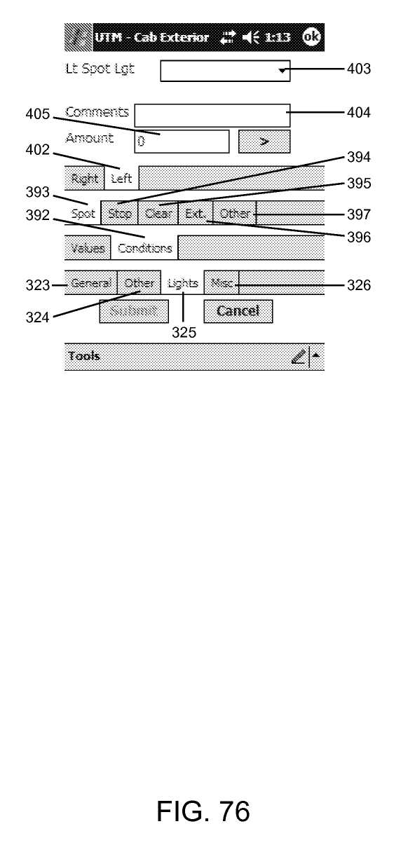

In the embodiment shown in FIG. 76, the Spot tab 393, e.g., accesses a Left tab 402, which may then access data fields for Left Spot Light 403, Comments 404 and Amount 405.

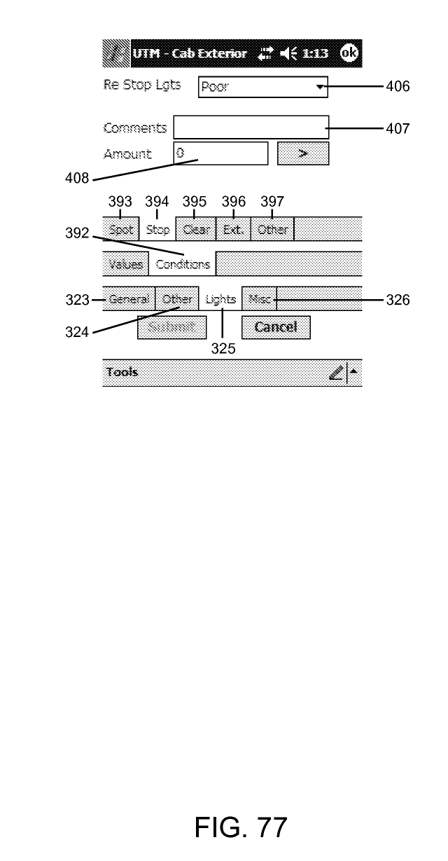

In the embodiment shown in FIG. 77, the Stop tab 394, e.g., accesses data fields for Rear Stop Lights 406, Comments 407 and Amount 408.

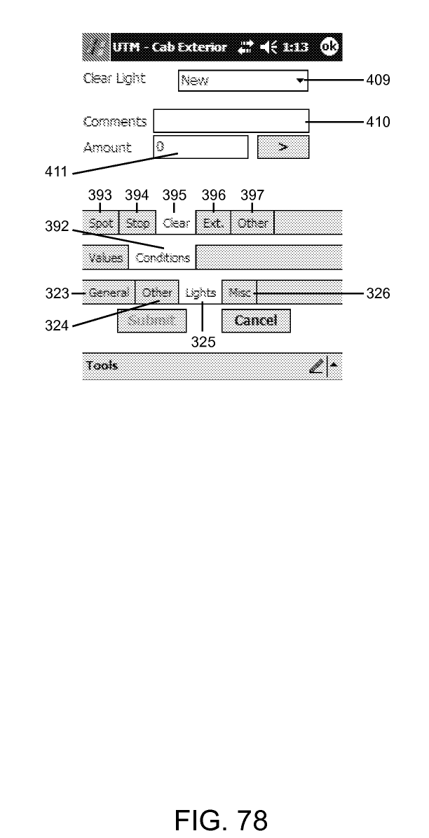

In the embodiment shown in FIG. 78, the Clear tab 395, e.g., accesses data fields for Clear Light 409, Comments 410 and Amount 411.

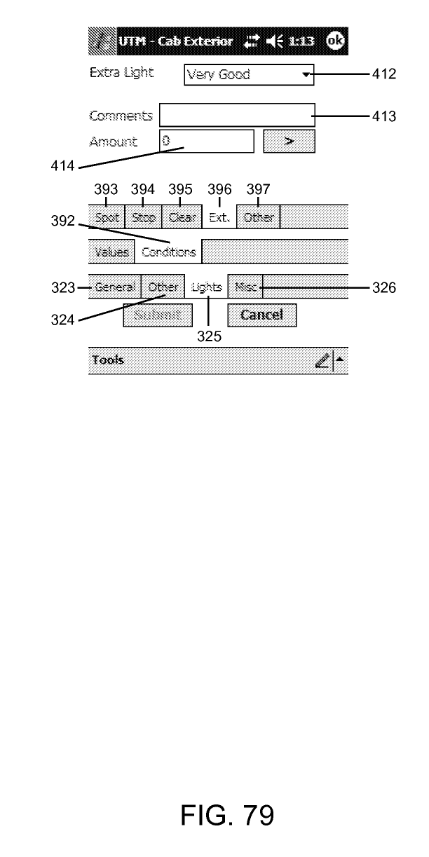

In the embodiment shown in FIG. 79, the Extra tab 396, e.g., accesses data fields for Extra Light 412, Comments 413 and Amount 414.

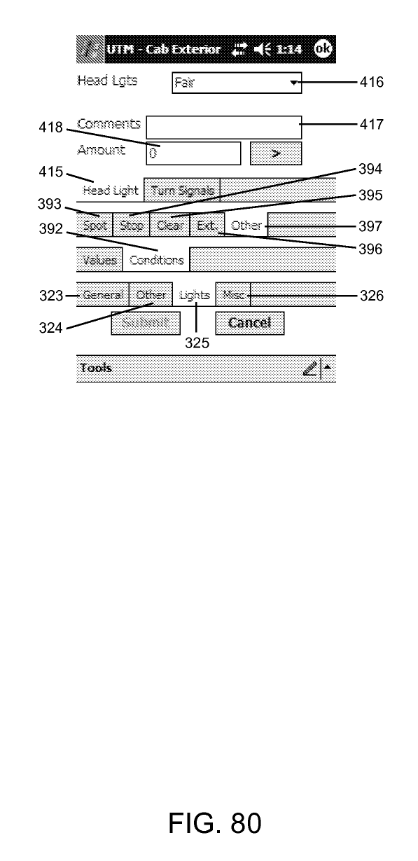

In the embodiment shown in FIG. 80, the Other tab 397, e.g., accesses a tab labeled Head Light 415, which may then access data fields for Head Lights 416, Comments 417 and Amount 418.

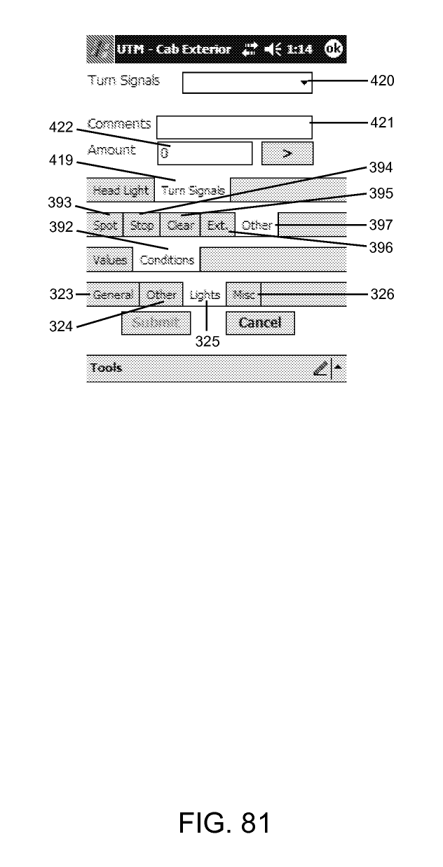

In the embodiment shown in FIG. 81, the Other tab 397, e.g., accesses a tab labeled Turn Signals 419, which may then access data fields for Turn Signals 420, Comments 421 and Amount 422.

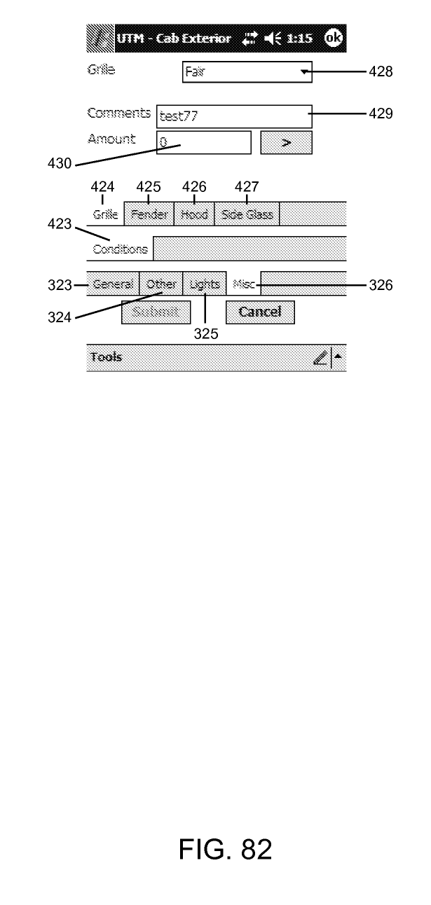

In the embodiments shown in FIGS. 82-87, the Miscellaneous 326 tab, e.g., accesses a Conditions tab 423, which may then access tabs labeled Grille 424, Fender 425, Hood 426, and Side Glass 427.

In the embodiment shown in FIG. 82, the Grille tab 424, e.g., accesses data fields for Grille 428, Comments 429 and Amount 430.

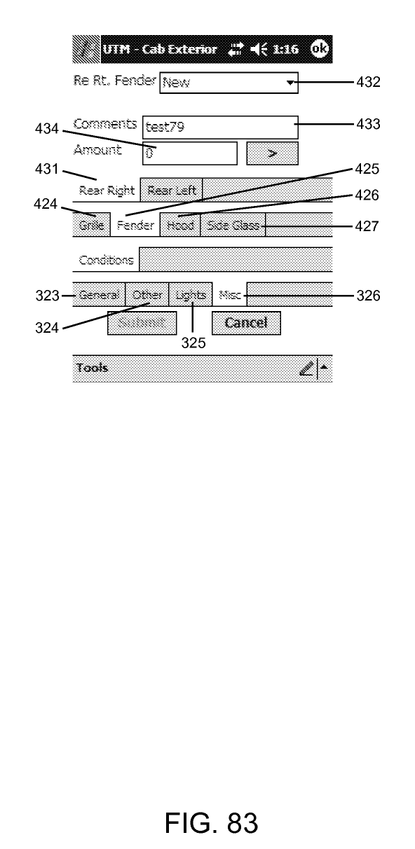

In the embodiment shown in FIG. 83, the Fender tab 425, e.g., accesses a tab labeled Rear Right 431, which may then access data fields for Rear Right Fender 432, Comments 433 and Amount 434.

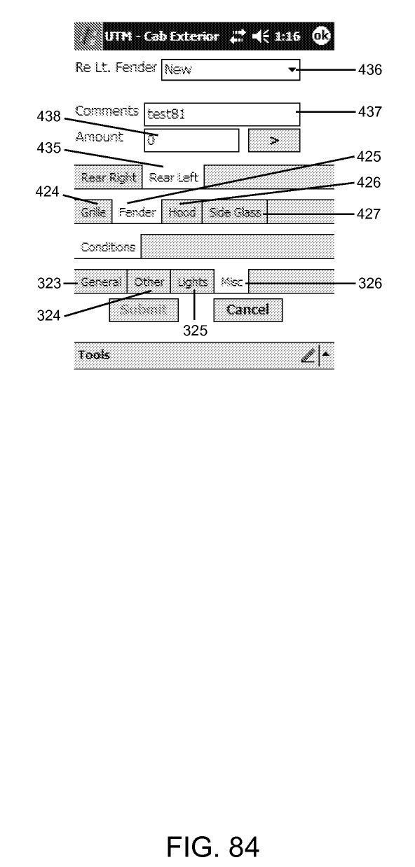

In the embodiment shown in FIG. 84, the Fender tab 425, e.g., accesses a tab labeled Rear Left 435, which may then access data fields for Rear Left Fender 436, Comments 437, and Amount 438.

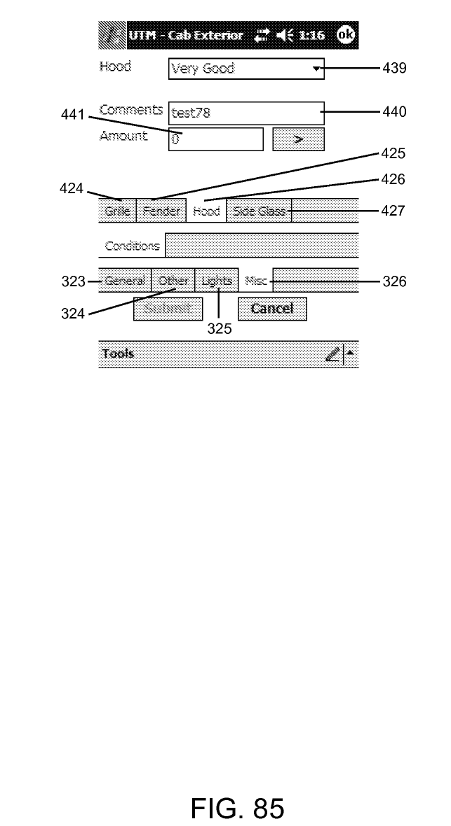

In the embodiment shown in FIG. 85, the Hood tab 426, e.g., accesses data fields for Hood 439, Comments 440 and Amount 441.

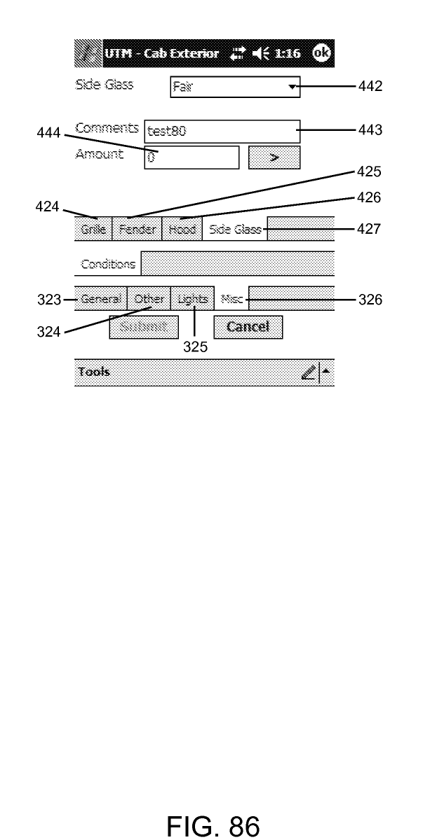

In the embodiment shown in FIG. 86, the Side Glass tab 427, e.g., accesses data fields for Side Glass 442, Comments 443 and Amount 444.

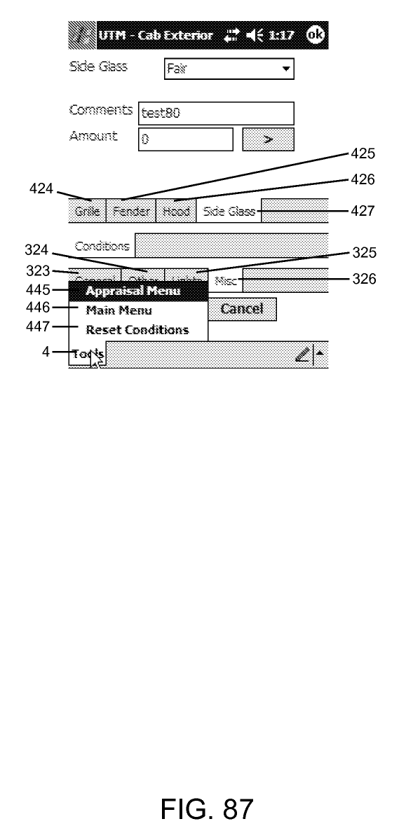

In the embodiment shown in FIG. 87, the Tools button 4 provides, e.g., navigation to the Appraisal Menu 445, Main Menu 446 and Reset Conditions 447.

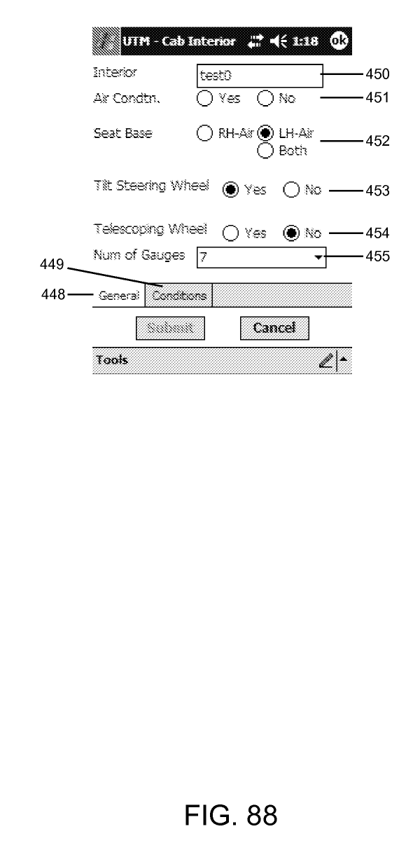

FIGS. 88-95 show the Cab Interior screen, depicted, e.g., as accessed from the Major Components option 95 on the Appraisal Menu screen shown in FIG. 22. The screen may then show two tabs labeled General 448 and Conditions 449.

In the embodiment shown in FIG. 88, the General tab 448, e.g., accesses data fields for Interior 450, Air Conditioning 451, Seat Base 452, Tilt Steering Wheel 453, Telescoping Wheel 454, and Number of Gauges 455.

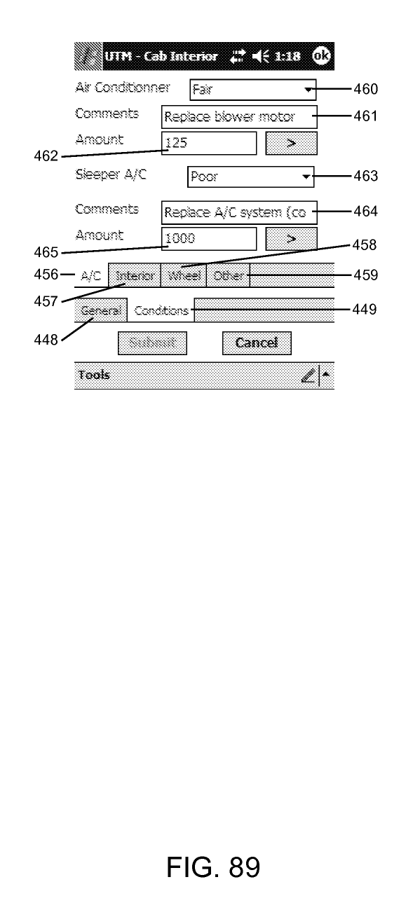

In the embodiments shown in FIGS. 89-95, the Conditions tab 449, e.g., accesses four tabs labeled A/C 456, Interior 457, Wheel 458, and Other 459.

In the embodiment shown in FIG. 89, the NC tab 456, e.g., accesses data fields for Air Conditioner 460, Comments 461 and Amount 462; and Sleeper A/C 463, Comments 464 and Amount 465.

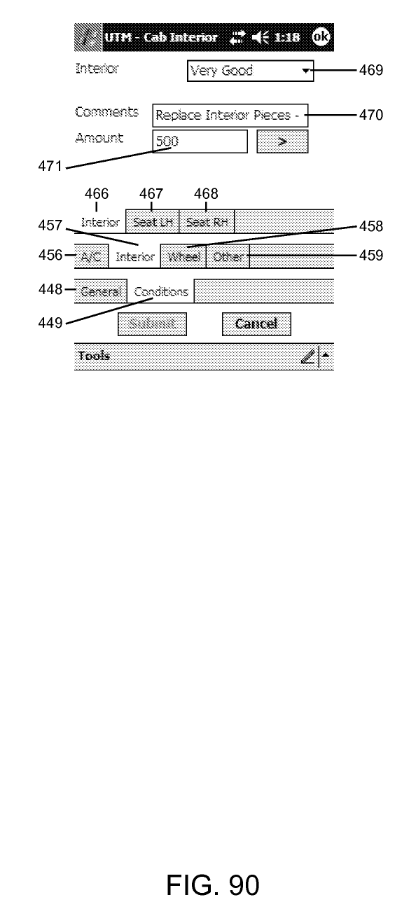

In the embodiment shown in FIGS. 90-92, the Interior tab 457, e.g., accesses three tabs labeled Interior 466, Seat Left Hand 467 and Seat Right Hand 468.

In the embodiment shown in FIG. 90, The second Interior tab 466, e.g., accesses data fields for Interior 469, Comments 470 and Amount 471.

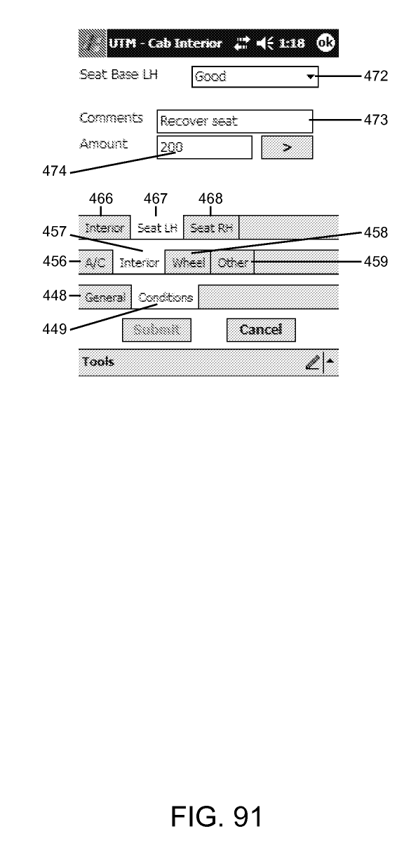

In the embodiment shown in FIG. 91, the Seat Left Hand tab 467, e.g., accesses data fields for Seat Base Left Hand 472, Comments 473 and Amount 474.

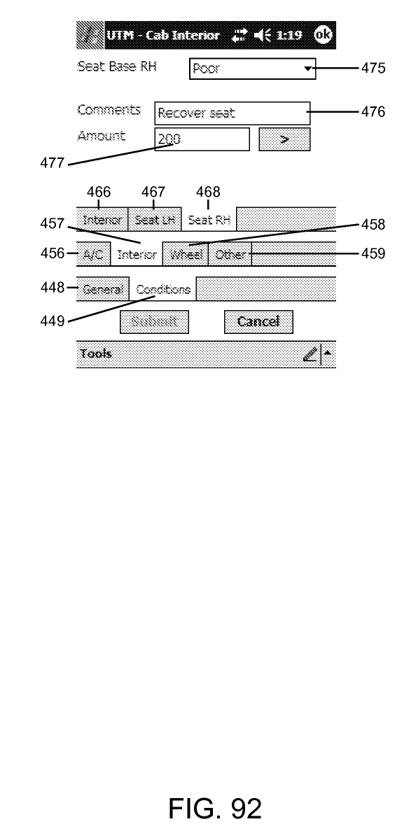

In the embodiment shown in FIG. 92, the Seat Right Hand tab 468, e.g., accesses data fields for Seat Base Right Hand 475, Comments 476 and Amount 477.

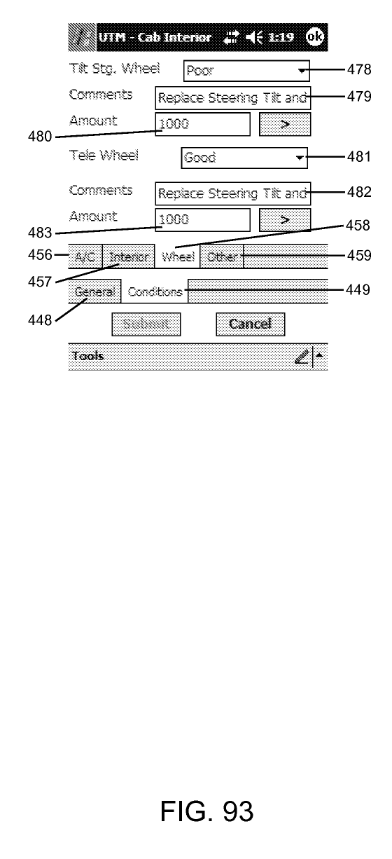

In the embodiment shown in FIG. 93, the Wheel tab 458, e.g., accesses data fields for Tilt Steering Wheel 478, Comments 479 and Amount 480; and also Telescoping Wheel 481, Comments 482 and Amount 483.

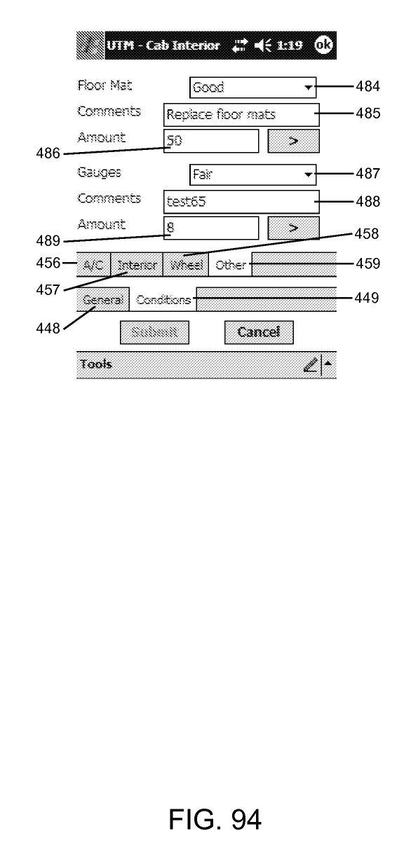

In the embodiment shown in FIG. 94, the Other tab 459, e.g., accesses data fields for Floor Mat 484, Comments 485 and Amount 486; and also Gauges 487, Comments 488 and Amount 489.

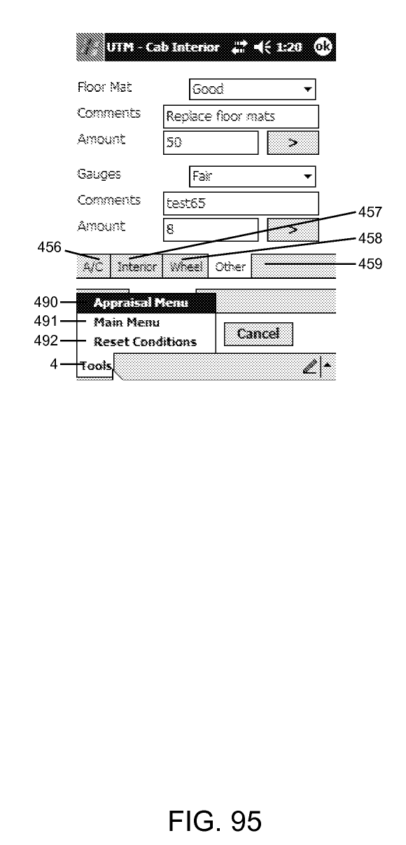

In the embodiment shown in FIG. 95, the Tools button 4, e.g., provides navigation to the Appraisal Menu 490, Main Menu 491 and Reset Conditions 492.

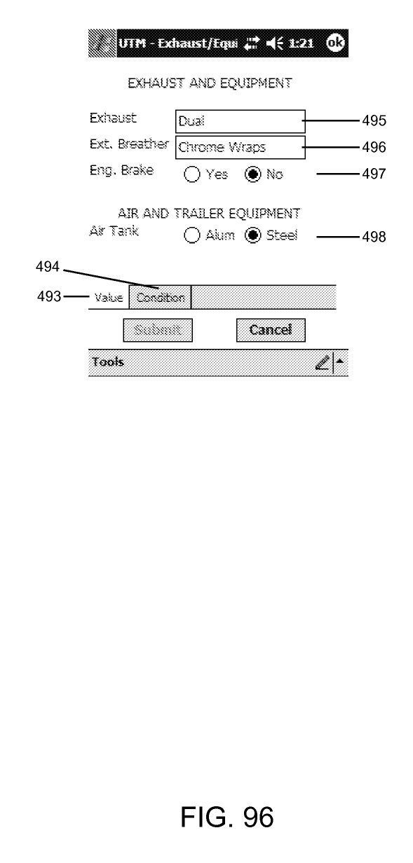

FIGS. 96-103 show the Exhaust/Equipment screen, depicted, e.g., as accessed from the Engine & Air button 99 on the Appraisal Menu screen shown in FIG. 22. The screen may then show two tabs labeled Value 493 and Condition 494.

In the embodiment shown in FIG. 96, the Value tab 493, e.g., accesses data fields for Exhaust 495, Exterior Breather 496, Engine Brake 497, and Air Tank 498. 151

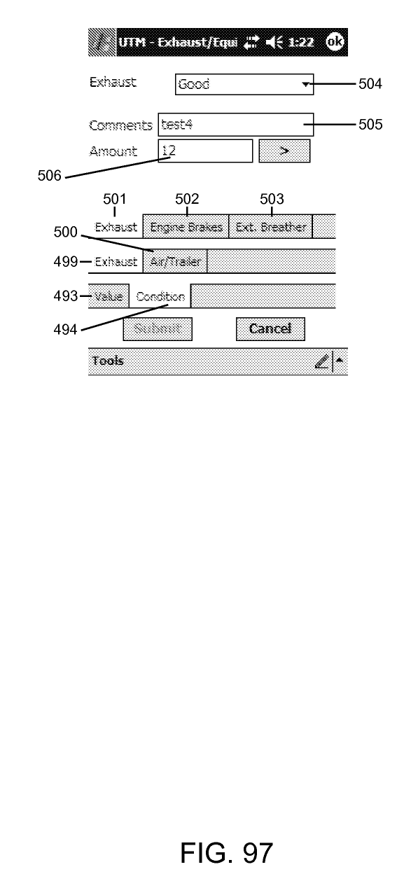

In the embodiments shown in FIGS. 97-103, the Condition tab 494, e.g., accesses two more tabs labeled Exhaust 499 and Air/Trailer 500.

In the embodiment shown in FIGS. 97-99, the first Exhaust tab 499 may access three tabs labeled Exhaust 501, Engine Brakes 502, and Exterior Breather 503.

In the embodiment shown in FIG. 97, the second Exhaust tab 501, e.g., accesses data fields for Exhaust 504, Comments 505 and Amount 506.

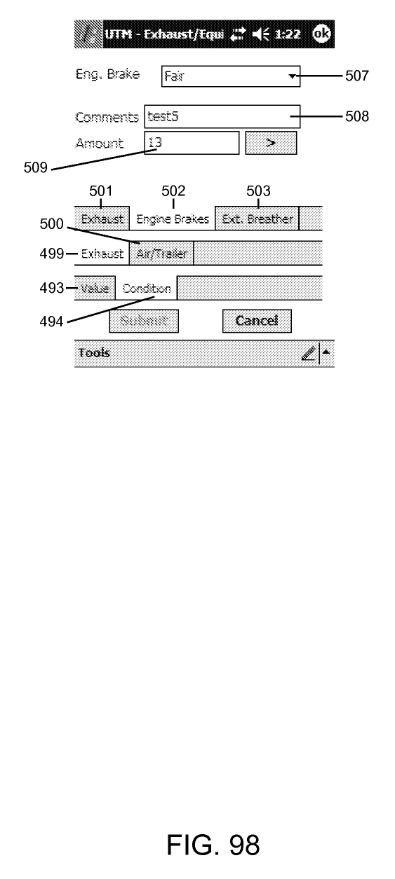

In the embodiment shown in FIG. 98, the Engine Brakes tab 502, e.g., accesses data fields for Engine Brakes 507, Comments 508 and Amount 509.

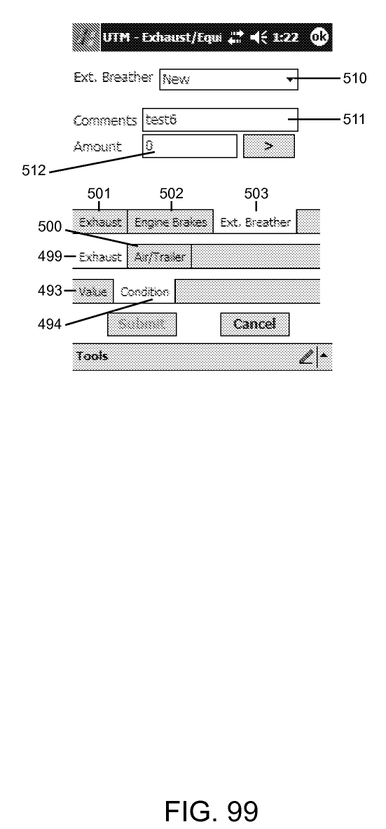

In the embodiment shown in FIG. 99, the Exterior Breather tab 503, e.g., accesses data fields for Exterior Breather 510, Comments 511 and Amount 512.

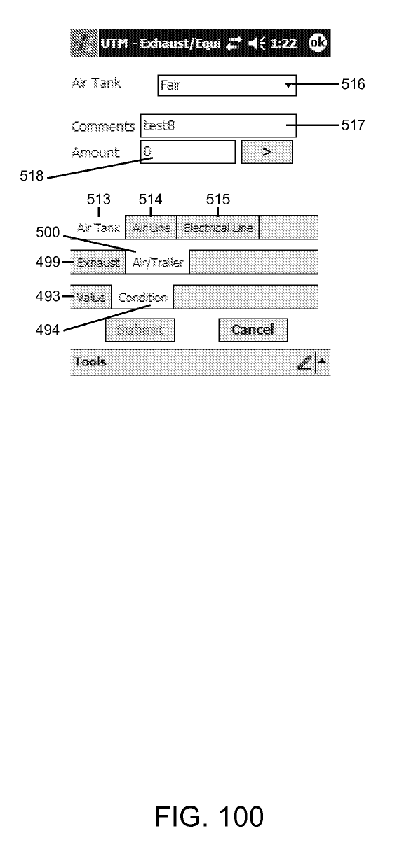

In the embodiment shown in FIGS. 100-103, the Air/Trailer tab 500 may access three tabs labeled Air Tank 513, Air Line 514 and Electrical Line 515.

In the embodiment shown in FIG. 100, the Air Tank tab 513, e.g., accesses data fields for Air Tank 516, Comments 517 and Amount 518.

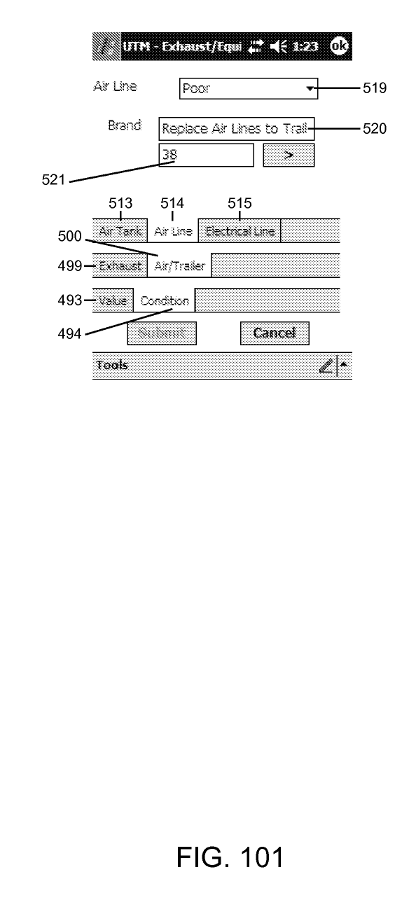

In the embodiment shown in FIG. 101, the Air Line tab 514, e.g., accesses data fields for Air Line 519, Brand 520 and Amount 521.

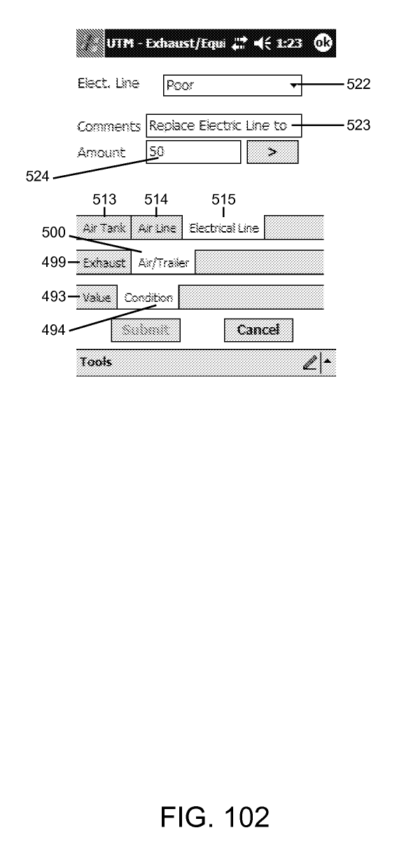

In the embodiment shown in FIG. 102, the Electrical Line tab 515, e.g., accesses data fields for Electrical line 522, Comments 523 and Amount 524.

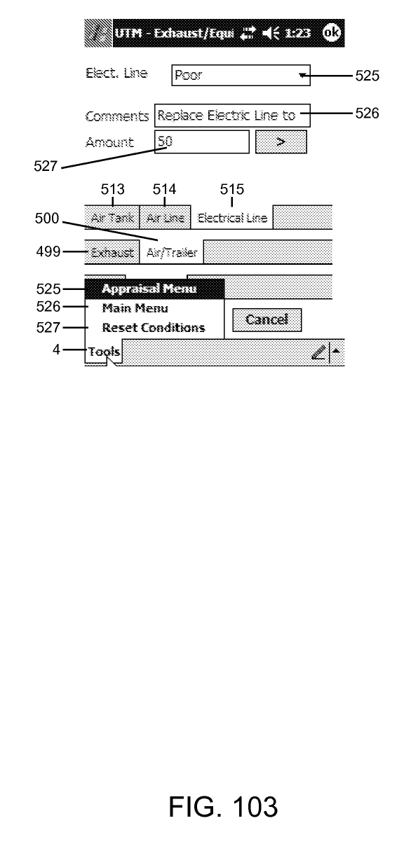

In the embodiment shown in FIG. 103, the Tools 4 button may provide navigation to the Appraisal Menu 525, Main Menu 526 and Reset Conditions 527.

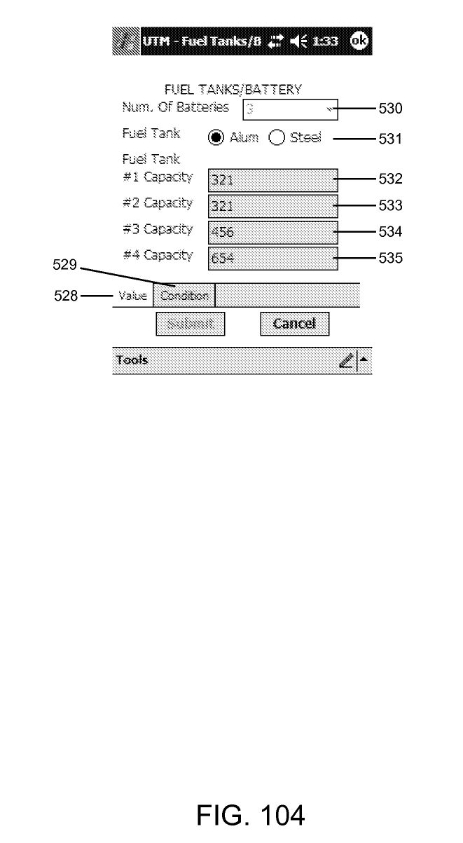

FIGS. 104-109 show the Fuel Tanks/Battery screen, depicted, e.g., as accessed from the Fuel & Battery button 100 on the Appraisal Menu screen shown in FIG. 22. The screen may then show two tabs labeled Value 528 and Condition 529.

In the embodiment shown in FIG. 104, the Value tab 528, e.g., accesses data fields for Number of Batteries 530, Fuel Tank 531, Fuel Tank #1 Capacity 532, Fuel Tank #2 Capacity 533, Fuel Tank #3 Capacity 534, and Fuel Tank #4 Capacity 535.

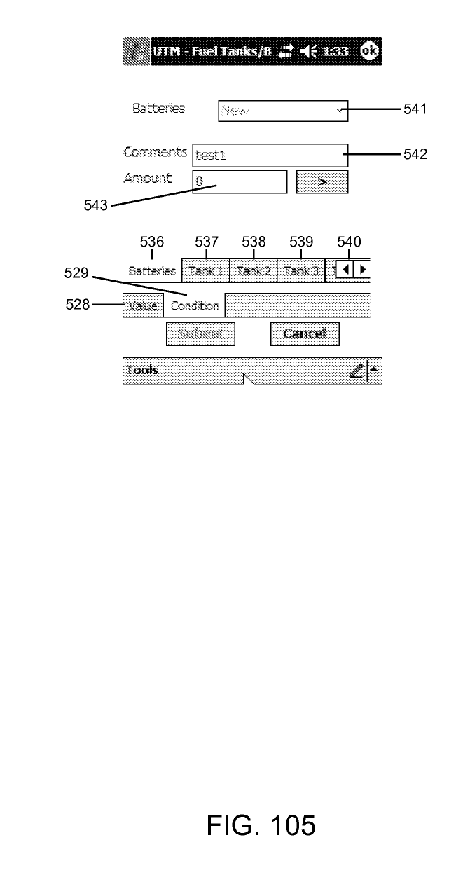

In the embodiment shown in FIGS. 105-109, the Condition tab 529, e.g., accesses five tabs labeled Batteries 536, Tank 1 537, Tank 2 538, Tank 3 539, and Tank 4 540. Scroll arrows may be employed to allow navigation to tabs not appearing on the screen.

In the embodiment shown in FIG. 105, the Batteries tab 536, e.g., accesses data fields for Batteries 541, Comments 542 and Amount 543.

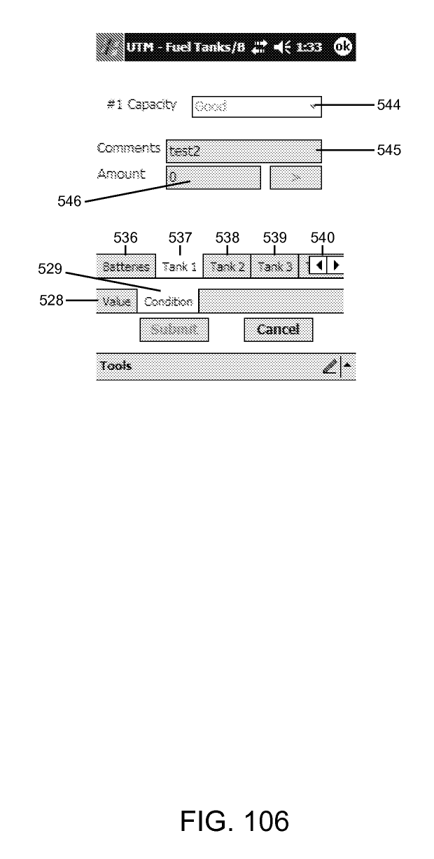

In the embodiment shown in FIG. 106, the Tank 1 tab 537, e.g., accesses data fields for #1 Capacity 544, Comments 545 and Amount 546.

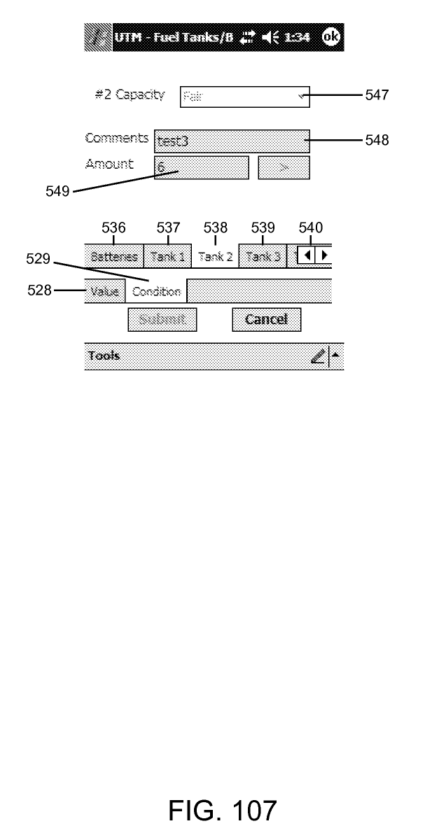

In the embodiment shown in FIG. 107, the Tank 2 tab 538, e.g., accesses data fields for #2 Capacity 547, Comments 548 and Amount 549.

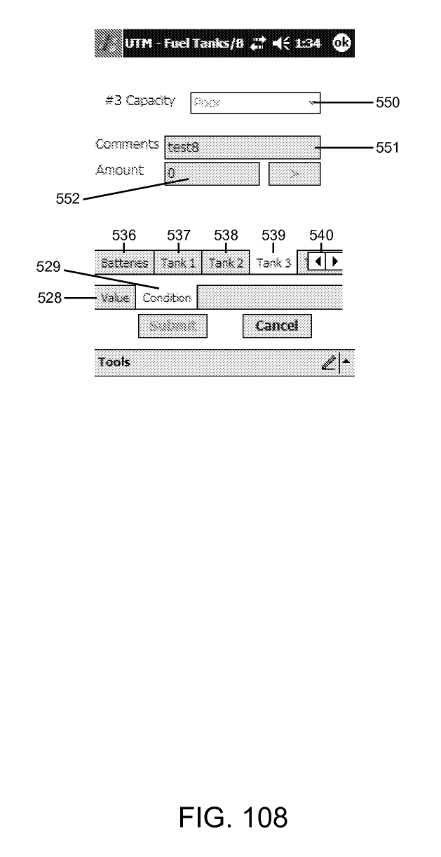

In the embodiment shown in FIG. 108, the Tank 3 tab 539, e.g., accesses data fields for #3 Capacity 550, Comments 551 and Amount 552.

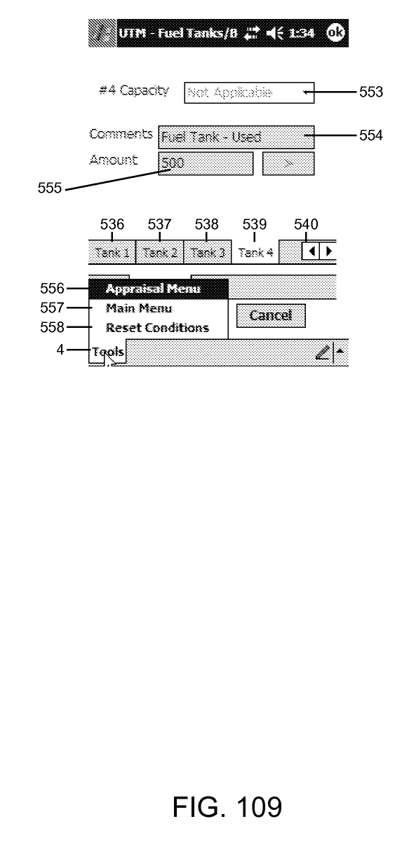

In the embodiment shown in FIG. 109, the Tank 4 tab 540, e.g., accesses data fields for #4 Capacity 553, Comments 554 and Amount 555. Also, the Tools button 4 may further provide navigation back to the Appraisal Menu 556, Main Menu 557 and Reset Conditions 558.

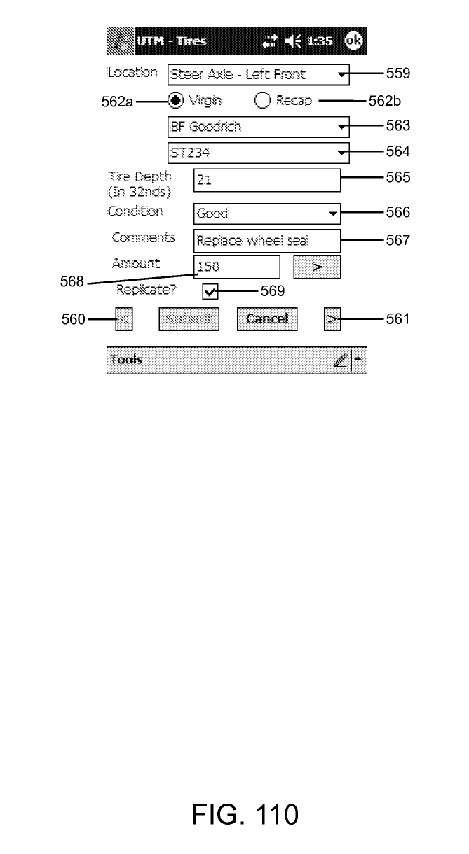

FIGS. 110-112 show an exemplary Tires screen sequence, depicted as accessed from the Tires button 101 on the Appraisal Menu screen shown in FIG. 22. The Tires data is displayed in a sequence of fourteen screens corresponding to each tire on typical heavy truck. The tire choices resulting in individual screens are, e.g., Left Steer Axle, Right Steer Axle, Left Outside Front Drive Axle, Left Inside Front Drive Axle, Right Outside Front Axle, Right Inside FrontAxle, Left Outside Rear Axle, Left Inside Rear Axle, Right Outside Rear Axle, Right Inside Rear Axle, Left Outside Auxiliary Axle, Left Inside Auxiliary Axle, Right Outside Auxiliary Axle, and Right Inside Auxiliary Axle. The screen may be the same whatever the position of the tire. There are two exemplary methods of navigating from one tire screen to the next. The first navigation method can be selecting the tire from a drop-down menu provided in the Location data field 559. The other navigation method can be indexing to the previous tire by clicking the “<” button 560, and to the next tire by clicking the “>” 561 button. The “<” button 560 and “>” button 561 may be unavailable to the user, thus indicating that the user is either at the first or last tire on the list, respectively.

In the embodiment shown in FIG. 110, data fields are , e.g., displayed for Location 559, Virgin 562a or Recap 562b, Tire Manufacturer 563, Tire Type 564, Tire Depth (in 32nds per Inch) 565, Condition 566, Comments 567 and Amount 568. Also included is an optional Replicate checkbox 569 for replicating selections into data fields for the next tire.

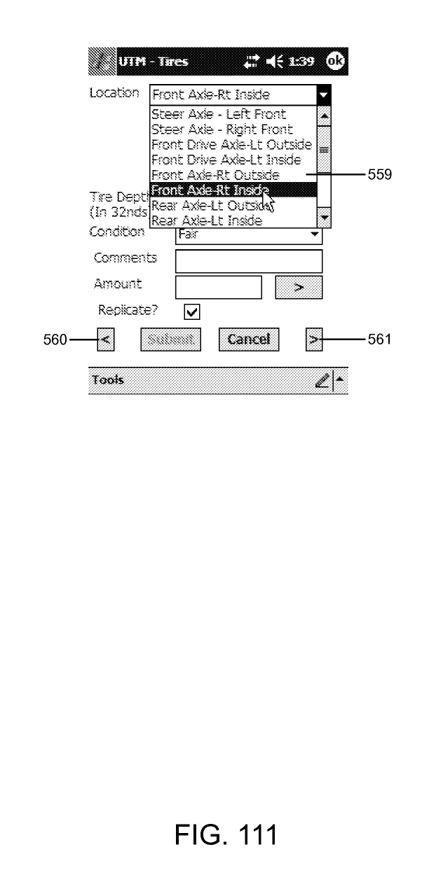

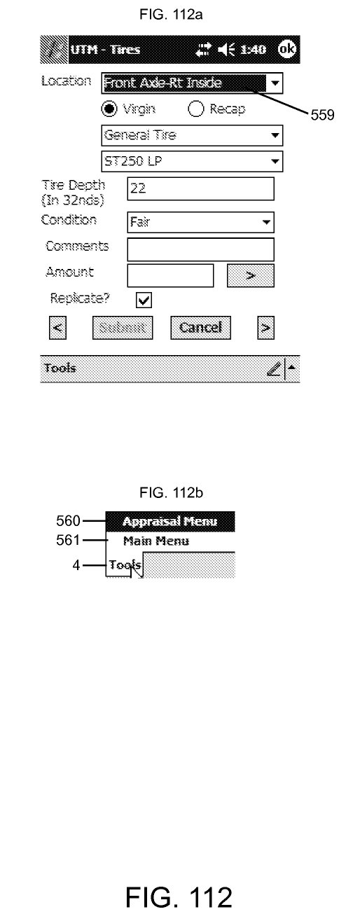

In the embodiment shown in FIG. 111, the Location data field 559, e.g., accesses a drop-down menu and scroll bar with all fourteen tires listed by location. Right Inside Front Axle as been selected in this example.

In the embodiment shown in FIG. 112a, the Location data field 559, e.g., indicates the selection of Right Inside Front Axle and corresponding data fields.

In the embodiment shown in FIG. 112b, the Tools button provides navigation to the Appraisal Menu 560 and Main Menu 561.

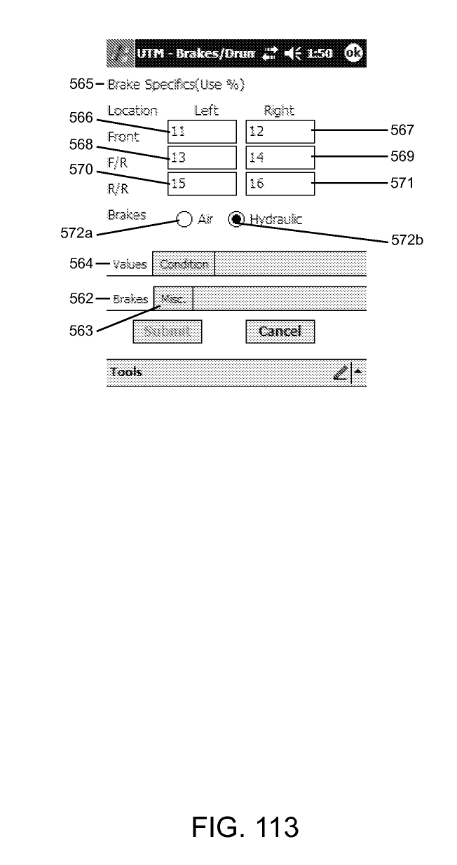

In FIGS. 113-120 an exemplary Brakes/Drums screen is depicted as accessed from the Brakes Drums button 102 on the Appraisal Menu screen shown in FIG. 22. The screen shows two tabs labeled, e.g., Brakes 562 and Miscellaneous 563.

In the embodiment shown in FIG. 113, the Brakes tab 562, e.g., accesses the Values tab 564, which may then access data fields for Brake Specifics 565 (indicating percentage of brake left), Front Left 566, Front Right 567, F/R Left Drive Axle 568, F/R Right Drive Axle 569, R/R Left 570, and R/R Right 571(indicating the location of the brake); and also Air 572a or Hydraulic 572b brakes.

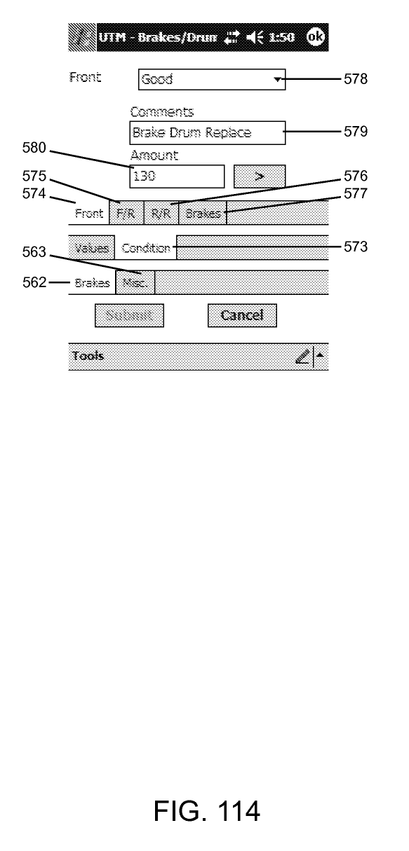

In the embodiment shown in FIGS. 114-117, the Brakes tab 562, e.g., accesses the Condition tab 573, which accesses four tabs labeled Front 574, Drive Axle (F/R) 575, Rear Axle (R/R) 576, and Brakes 577.

In the embodiment shown in FIG. 114, the Front tab 574, e.g., accesses data fields for Front 578, Comments 579 and Amount 580.

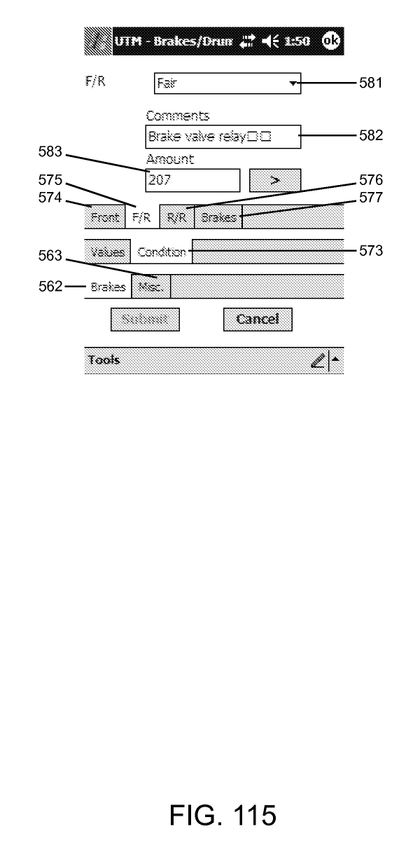

In the embodiment shown in FIG. 115, the F/R tab 575, e.g., accesses data fields for F/R 581, Comments 582 and Amount 583.

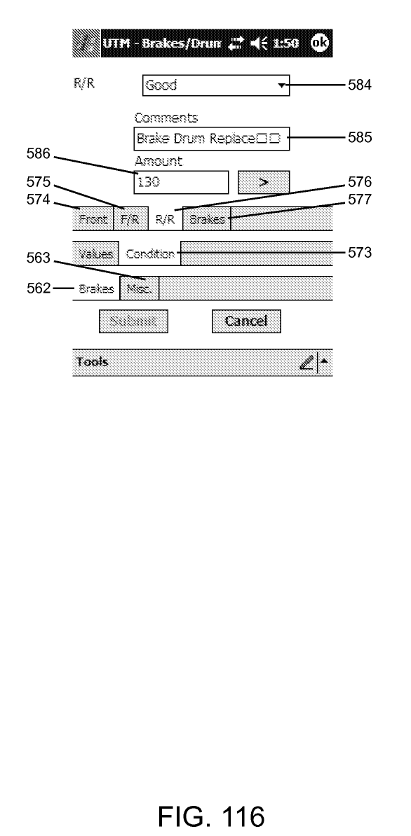

In the embodiment shown in FIG. 116, the R/R tab 576, e.g., accesses data fields for R/R 584, Comments 585 and Amount 586.

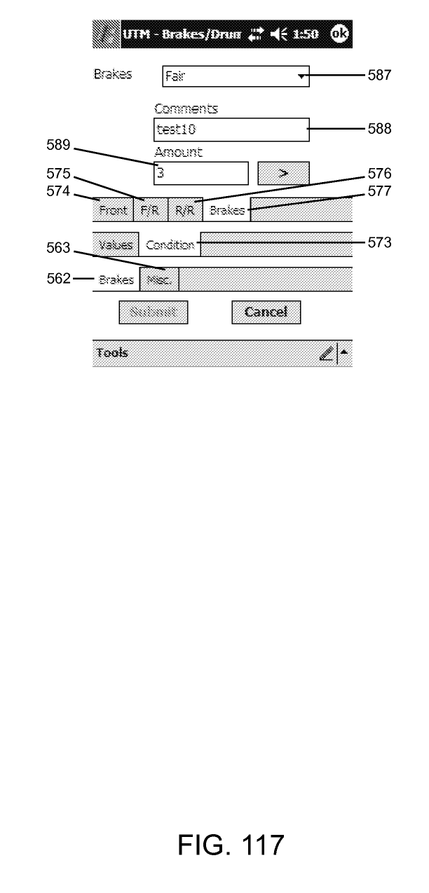

In the embodiment shown in FIG. 117, the Brakes tab 577, e.g., accesses data fields for Brakes 587, Comments 588 and Amount 589.

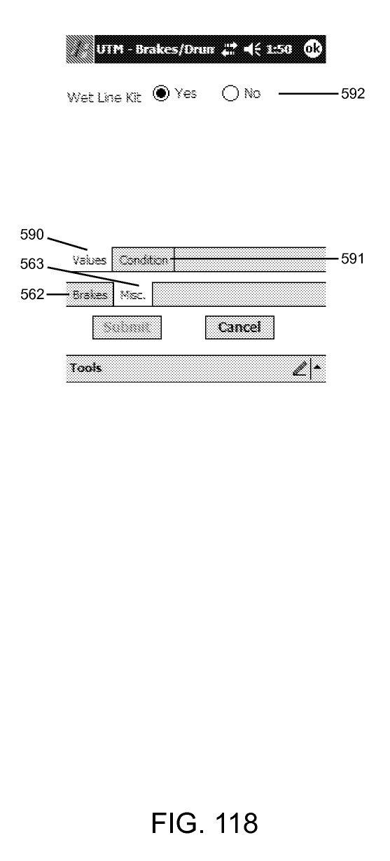

In the embodiment shown in FIGS. 118-120, the Miscellaneous tab 563, e.g., accesses two tabs labeled Values 590 and Condition 591.

In the embodiment shown in FIG. 118, the Values tab 590, e.g., accesses a data field for Wet Line Kit 592.

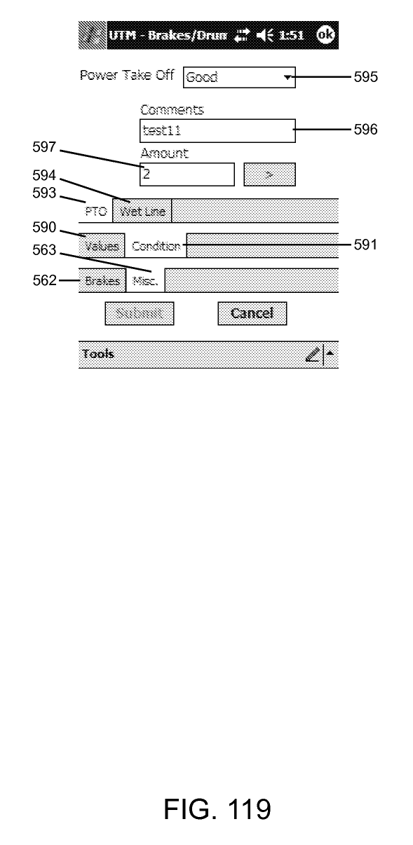

In the embodiment shown in FIG. 119, the Condition tab 591, e.g., accesses two tabs labeled PTO 593 and Wet Line 594. The PTO tab may access data fields for Power Take Off 595, Comments 596 and Amount 597.

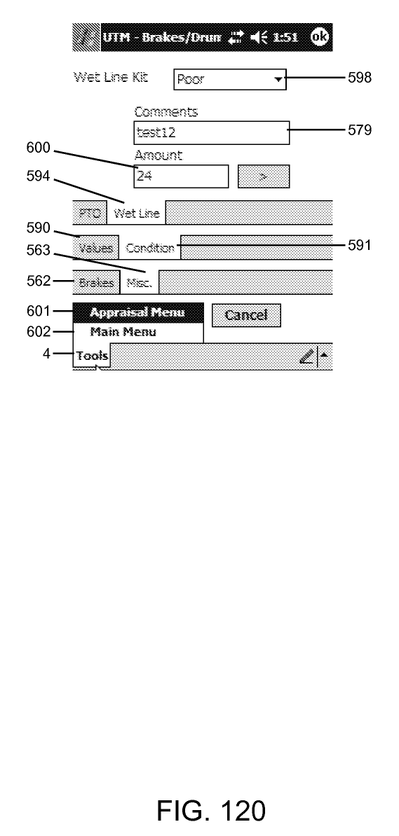

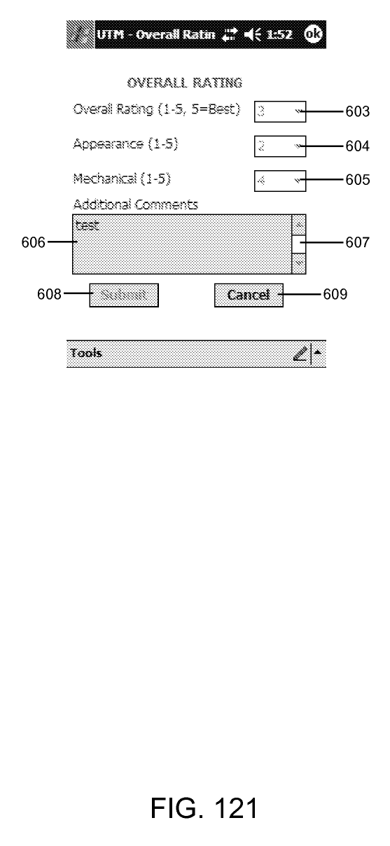

In the embodiment shown in FIG. 120, the Wet Line 594 tab, e.g., accesses data fields for Wet Line Kit 598, Comments 599 and Amount 600. The Tools button 4 may provide further navigation to the Appraisal Menu 601 and Main Menu 602.

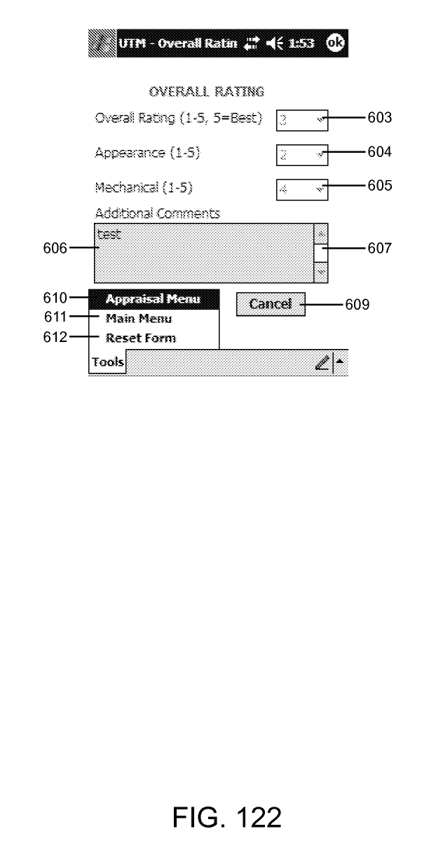

FIGS. 121-122 depict an exemplary Overall Rating screen. In FIG. 121, the Overall Rating screen is depicted as accessed from the Rating button 103 on the Appraisal Menu screen shown in FIG. 22. The screen shows four data fields labeled, e.g., Overall Rating 603, Appearance 604, Mechanical 605, and Additional Comments 606. A scroll bar may be provided to allow navigation through the Additional Comments data field 607. Submit 608 and Cancel buttons 609 may be employed to end the screen session. Optionally, the software can be programmed to total and average numerical values, based on a Likert scale or rating scale, corresponding to component conditions such as good, fair, and poor, which were previously entered along with recorded recondition amounts and displayed as the average of all component condition values.

In the embodiment shown in FIG. 122, the Tools button 4, e.g., provides navigation to the Appraisal Menu 610, Main Menu 611, and Reset Form 612. Here, the Reset Form option 612 may initialize all possible previous entered values.

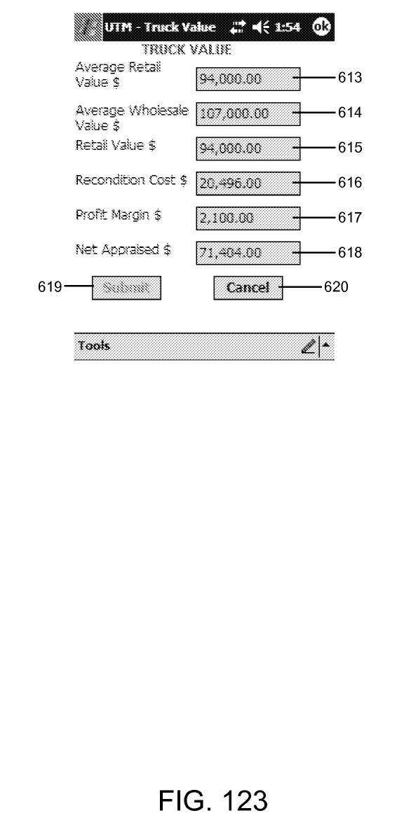

FIGS. 123-125 depict an exemplary Truck Value screen. In FIG. 123, the Truck Value screen is depicted, e.g., as accessed from the Truck Value button 104 on the Appraisal Menu screen shown in FIG. 22. The screen shows six data fields labeled, e.g., Average Retail Value $ 613, Average Wholesale Value $ 614, Retail Value $ 615, Recondition Cost $ 616, Profit Margin $ 617, and Net Appraised $ 618. Submit 619 and Cancel 620 buttons may also be provided to end the screen session. The Average Retail Value $ 613 and Average Wholesale Value $ 614 data fields are preferably linked to a local database that is updated with current wholesale and retail sales data from multiple dealer databases. The updated wholesale and retail sales data is averaged and displayed to the user in response to search criteria previously entered by the user, as shown, e.g., in FIGS. 7-21, via the PDA and hand-held scanner, allowing the user to then determine and input an informed retail value for a specific vehicle in the Retail Value $ 615 data field. The Recondition Cost $ 616 data field is preferably populated with the total of amounts individually entered in each Amount data field shown, e.g., in FIGS. 47-51, 53-56, 58-61, 63-68, 70-73, 75-87, 89-95, 97-103, 105-112a, 114-117, 119, and 120.

The Profit Margin $ data field 617 may be automatically populated with a fixed profit margin value determined by the user. Optionally, a set percentage of the Retail Value $ data field 615 can be programmed to automatically appear in the Profit Margin $ data field 617 or manually entered. The Net Appraised $ 618 may be output to the user after being determined via the equation:

Retail Value $−Recondition Cost $−Profit Margin $=Net Appraised $

The Net Appraised $ 618 is the price a heavy truck dealer should pay for a specific heavy truck, said Net Appraised $ 618 taking into account and providing a specific discount value for each used heavy truck system component. Optionally, also included in the Net Appraised $ calculation are custom adjustments made by the user to either individual Recondition Cost 616, Retail Value $ 615, or Profit Margin $ 617.

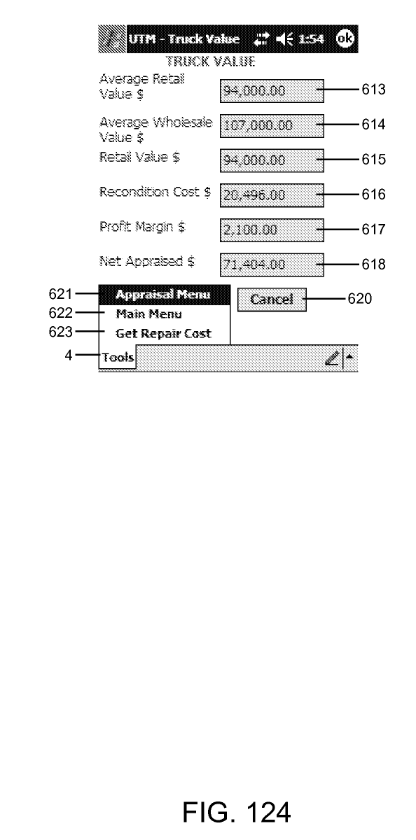

In the embodiment shown in FIG. 124, the Tools button 4, e.g., provides navigation to the Appraisal Menu 621, Main Menu 622, and Get Repair Cost 623. Here, the Get Repair Cost option 623 preferably recalculates Recondition Cost $ 616 and Net Appraised $ 618 based on the price point at which the truck can actually be repaired.

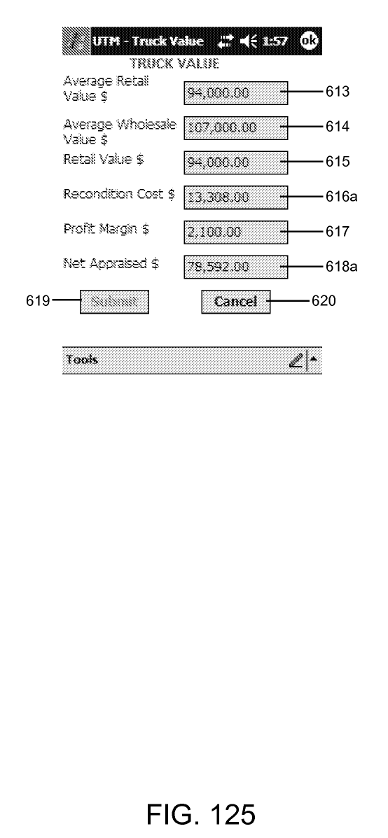

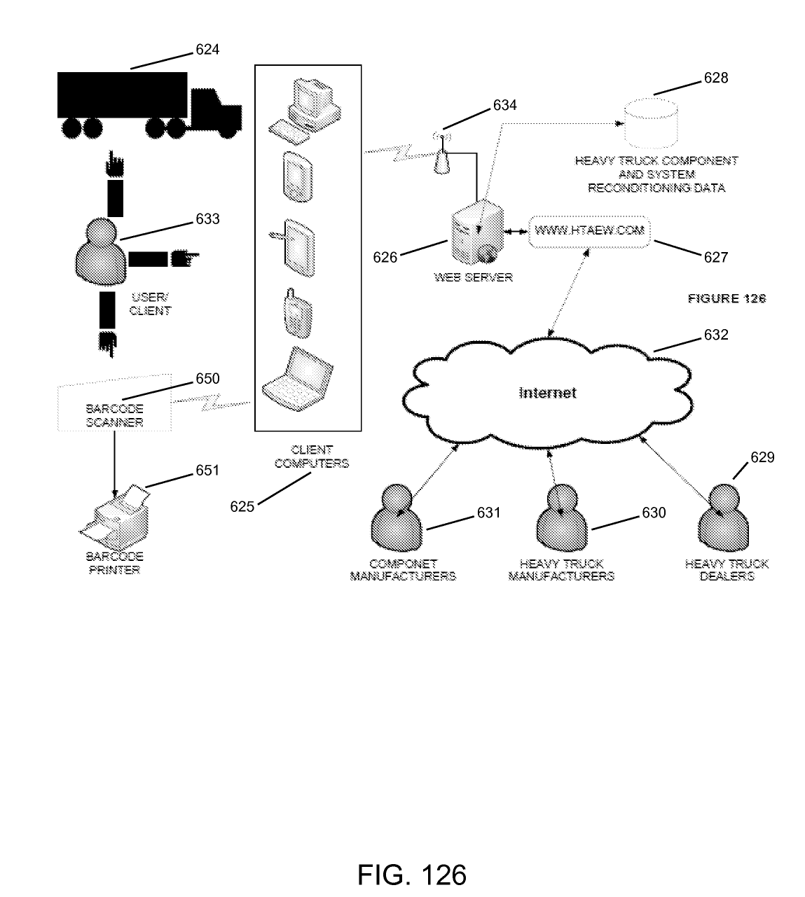

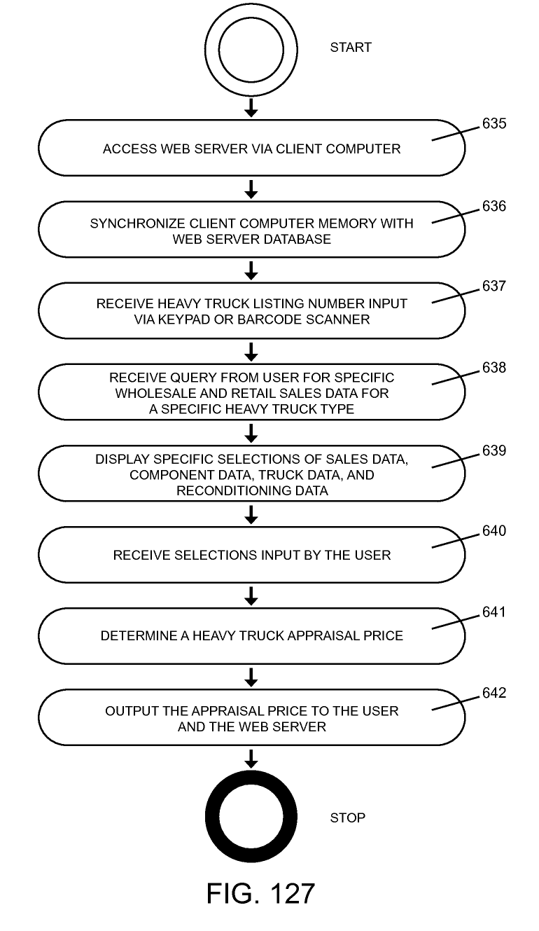

In the embodiment shown in FIG. 125, the recalculated Recondition Cost $ 616a and Net Appraised $ 618a are displayed after using the Get Repair Cost 623 function in FIG. 124.

In the embodiment shown in FIG. 126, an exemplary apparatus for determining the appraisal price of a heavy truck 624 with a client computer 625 and a web server 626 is shown. The web server 626 hosts a web site 627 and is updated with, e.g., wholesale and retail sales data for a heavy truck provided through the internet 632 heavy truck dealers 629, manufacturer-specific component and system information provided via heavy truck manufacturers 630 and component manufacturers 631, and recondition cost information provided via a heavy truck component and system reconditioning database 628. The apparatus may further comprise a client computer 625 or other device for accessing a web server 626; synchronization software for synchronizing the local memory on the client computer with the web server; data fields for receiving a vehicle listing number input by the user 633, which may be input by use of Barcode Scanner 650; a Barcode Printer 651 for printing a barcode that corresponds with a listing number; a graphical user interface for displaying selections of wholesale and retail sales data for a heavy truck, manufacturer-specific component and system information, and recondition cost information; data fields for receiving selections input by the user; a processor for determining an appraisal price from selections input by the user; a graphical user interface for outputting the appraisal price to the user; and a transmitter 634 for outputting the appraisal price to the web server.

In the embodiment shown in FIG. 127, an exemplary method is provided for determining the appraisal price of a heavy truck with a client computer and a web server. FIG. 127 also describes instructions embodied on a computer program product for use with a client computer operatively connected to a web server for determining the appraisal price of a heavy truck. The web server is updated with wholesale and retail sales data for a heavy truck, manufacturer-specific component and system information, and recondition cost information. Determining the appraisal price includes, e.g., accessing a web server via the client computer 635; synchronizing the local memory on the client computer with the web server 636; receiving a vehicle listing number input by the user 637; receiving a query from the user for specific wholesale and retail sales data for a specific heavy truck type 638, displaying selections for wholesale and retail sales data for a heavy truck, manufacturer-specific component and system information, and recondition cost information in response to the listing number previously input by the user 639; receiving selections input by the user 640; determining an appraisal price from selections input by the user 641; and outputting the appraisal price to the user and the web server 642.

The present specification provides a complete description of the systems, methods and computer program products for calculating an appraisal price for a heavy truck as examples of the presently-described technology. Although various aspects of this technology have been described above with a certain degree of particularity, or with reference to one or more individual aspects, those skilled in the art could make numerous alterations to the disclosed aspects of the invention without departing from the spirit or scope of the technology hereof. For example, the graphical user interface, data entry screens, options and operations shown could vary in layout, terminology, placement, general look and feel, mode of accessibility, and the like. Since many aspects can be made without departing from the spirit and scope of the presently described technology, the appropriate scope resides in the claims hereafter appended, and other aspects are therefore contemplated. Furthermore it should be understood that any operations may be performed in any order, unless explicitly claimed otherwise or a specific order is inherently necessitated by the claim language. It is intended that all matter contained in the above description and shown in the accompanying drawings shall be interpreted as illustrative only of particular aspects and are not limiting to the embodiments shown. Changes in detail or structure may be made without departing from the basic elements of the present technology as defined in the following claims. Unless the term “means” is used, none of the features or elements in the claims below should be construed as means-plus-function limitations pursuant to 35 U.S.C. §112, ¶6.

What is claimed is:

1. A computer program product for use with a client computer operatively connected to a web server, wherein said web server is updated with wholesale and retail sales data for a heavy truck, manufacturer-specific component and system information, and recondition cost information, the computer program product comprising a computer-readable medium having program code instructions for directing the client computer to:
access a web server;
synchronize the local memory on the client computer with the web server; receive vehicle listing number input by the user;
display selections for wholesale and retail sales data for a heavy truck, manufacturer-specific, component and system information, and recondition cost information;
receive selections input by the user;
determine an appraisal price from selections input by the user; and
output the appraisal price to the user and the web server.

2. The product of claim 1, wherein the client computer is a personal digital assistant device comprising a bar code scanner.

3. The product of claim 1, wherein the computer program product comprising a computer-readable medium further comprises program instructions for directing the client computer to receive a vehicle listing number input by the user.

4. The product of claim 1, wherein said selections input by the user comprise a vehicle listing number input through the use of a bar code scanner.

5. The product of claim 1, wherein said selections input by the user comprise a vehicle listing number input through the use of a radio frequency identification device.

6. The product of claim 1, wherein said selections input by the user comprise a profit margin.

7. The product of claim 1, wherein the computer program product comprising a computer-readable medium further comprises program instructions for calculating a profit margin based on a percentage of the retail value.

8. The product of claim 1, wherein the computer program product comprising a computer-readable medium further comprises program code instructions for directing the client computer to allow the user to manually enter one or more of retail price, wholesale price, recondition costs, profit margin, or appraisal price.

9. The product of claim 1, wherein an appraisal price is determined by subtracting recondition costs and profit margin from retail value.

10. The product of claim 1 wherein the computer program product comprising a computer-readable medium further comprises program code instructions for directing the client computer to cause a bar code that corresponds with a listing number to be printed.

11. A method for determining the appraisal price of a heavy truck with a client computer and a web server, wherein said web server is updated with wholesale and retail sales data for a heavy truck, manufacturer-specific component and system information, and recondition cost information, comprising the steps of:
allowing access to a web server by a client computer;
synchronizing the local memory on the client computer with the web server;
receiving a vehicle listing number input by the user;
causing the client computer to display selections for wholesale and retail sales data for a heavy truck, manufacturer-specific component and system information, and recondition cost information;
receiving selections input by the user;
determining an appraisal price from selections input by the user; and
outputting the appraisal price to the user and the web server.

12. The method of claim 11, wherein the vehicle listing number input by the user is input through the use of a bar code scanner or radio frequency identification device.

13. The method of claim 11 wherein the selections input by the user comprise a profit margin.

14. The method of claim 11, wherein the method of determining appraisal price comprises subtracting recondition costs and profit margin from retail value.

15. The method of claim 11 comprising the additional step of:
receiving adjusted selections input by the user; and
outputting a revised appraisal price based on the adjusted selection

16. An apparatus for determining the appraisal price of a heavy truck with a client computer and a web server, wherein said web server is updated with wholesale and retail sales data for a heavy truck, manufacturer-specific component and system information, and recondition cost information, comprising:
a client computer for accessing a web server;
synchronization software for synchronizing the local memory on the client computer with the web server;
data fields for receiving a vehicle listing number input by the user;
a graphical user interface for displaying selections for wholesale and retail sales data for a heavy truck, manufacturer-specific component and system information, and recondition cost information;
data fields for receiving selections input by the user;
a processor for determining an appraisal price from selections input by the user;
a graphical user interface for outputting the appraisal price to the user; and
a transmitter for outputting the appraisal price to the web server.

17. The apparatus of claim 16, wherein said client computer is a personal digital assistant.

18. The apparatus of claim 16, further comprising a bar code scanner for inputting a vehicle listing number.

19. The apparatus of claim 16, further comprising a radio frequency input device for inputting a vehicle listing number.

20. The apparatus of claim 16, further comprising a printer for printing a bar code that corresponds with a listing number.
